(19) United States
(12) Patent Application Publication
(10) Pub. No.: US 2013/0145474 A1
(43) Pub. Date: Jun. 6, 2013

(54) CONCEALING AND REVEALING MESSAGE DATA

(71) Applicants: Aryeh MERGI, Bazra (IL); Ram COHEN, Tel Aviv (IL)

(72) Inventors: Aryeh MERGI, Bazra (IL); Ram COHEN, Tel Aviv (IL)

(73) Assignee: ACTIVEPATH LTD., Petah-Tiqva (IL)

(21) Appl. No.: 13/312,086

(22) Filed: Dec. 6, 2011

(51) Int. Cl. H04L 9/32; H04L 9/00

(52) U.S. Cl. 726/26

(57) ABSTRACT

Systems, methods, computer program products, and networks for messaging. In some examples the identity of a sending user of a message and/or other data is initially concealed when the (manipulated) message or an associated created message is sent to an intended receiving user. In these examples, revealing data which enables determination of at least some data which the sent message concealed is only provided upon request, and in some of these examples, only after a user has been authenticated as being an intended receiving user.

### TECHNICAL FIELD OF THE PRESENTLY DISCLOSED SUBJECT MATTER

The presently disclosed subject matter relates to the field of messaging.

### BACKGROUND OF THE PRESENTLY DISCLOSED SUBJECT MATTER

Although messaging has become a popular method of communication, the privacy of messages may not always be guaranteed. For example, a person other than the intended receiving user may be able to gain access to a message. The access may be, for instance, via the Internet Service Provider of the receiving user, webmail provider of the receiving user, or otherwise. In some cases, the message may include information which the intended receiving user, sending user, and/or other interested party would not want disclosed to a third party. For instance, a receiving user may not want a third party to know that the receiving user receives messages from a certain bank, since then the third party would assume, probably accurately, that the receiving user has an account at that bank. Additionally or alternatively, for instance, the receiving user may not want a third party to see the subject of a message, and/or some or all of the other data.

### SUMMARY

In one aspect, the disclosed subject matter provides a method of providing revealing data which enables determination of at least some data which a message concealed, comprising: receiving a request relating to a sent message which concealed data; and in response to the request, providing revealing data which enables determination of at least some data which the message concealed.

In another aspect, the disclosed subject matter provides a method of concealing message data, comprising: receiving an indication of a message which is intended for at least one receiving user, and sending a message to at least one of the at least one intended receiving user which conceals at least some data that would not be concealed if the indicated message were sent to the at least one of the at least one intended receiving user; wherein revealing data which enables determination of at least some data which the message concealed, is only provided to an intended receiving user upon request.

In another aspect, the disclosed subject matter provides a method of concealing and revealing message data, comprising: providing an indication of a message from the sending user which is intended for at least one receiving user; sending a message to at least one of the at least one intended receiving user which conceals data; providing a request relating to the sent message; in response to a request relating to the sent message, providing revealing data which enables determination of at least some data which the message concealed; and outputting to a user at least some data which the message concealed and which the revealing data enabled to determine.

In another aspect, the disclosed subject matter provides a receiving system, comprising: a user output operable to output at least some data which a sent message concealed and which revealing data, provided upon request, enabled to determine.

In another aspect, the disclosed subject matter provides a system for concealing and revealing data, comprising: a communicator operable to receive indication of a message from a sending user which is intended for at least one receiving user, to send a message to at least one of the at least one receiving user which conceals data, and to receive a request for revealing data which enables determination of at least some data which the message concealed; and an authenticator operable to authenticate or not authenticate a user associated with the request as being an intended receiving user of the message; wherein the communicator is further operable to send revealing data which enables determination of at least some data which the message concealed, if the user has been authenticated as being an intended receiving user of the message.

In another aspect, the disclosed subject matter provides a sending system, comprising: a message producer operable to produce a message intended for at least one receiving user; wherein instead of the produced message being sent to an intended receiving user, a message derived from manipulating the message or a part thereof, or a created message is sent to the intended receiving user and conceals data which would not have been concealed had the produced message been sent; and wherein revealing data which enables determination of at least some data which the sent out message concealed is provided only upon request.

In another aspect, the disclosed subject matter provides a computer program product comprising a computer useable medium having computer readable program code embodied therein for providing revealing data which enables determination of at least some data which a message concealed, the computer program product comprising: computer readable program code for causing the computer to receive a request relating to a sent message which concealed data; and computer readable program code for causing the computer, in response to the request, to provide revealing data which enables determination of at least some data which the message concealed.

In another aspect, the disclosed subject matter provides a computer program product comprising a computer useable medium having computer readable program code embodied therein for concealing message data, the computer program product comprising: computer readable program code for causing the computer to receive an indication of a message which is intended for at least one receiving user; and computer readable program code for causing the computer to send a message to at least one of the at least one intended receiving user which conceals at least some data that would not be concealed if the indicated message were sent to the at least one of the at least one intended receiving user; wherein revealing data which enables determination of at least some data which the message concealed, is only provided to an intended receiving user upon request.

### BRIEF DESCRIPTION OF THE DRAWINGS

In order to understand the presently disclosed subject matter and to see how it may be carried out in practice, embodiments will now be described, by way of non-limiting example only, with reference to the accompanying drawings, in which:

FIG. 1 is a high level block diagram of a network for messaging, according to some embodiments of the presently disclosed subject matter;

FIG. 2 is a more detailed block diagram of a sending system, according to some embodiments of the presently disclosed subject matter;

FIG. 3 is a flowchart illustration of a sending method, according to some embodiments of the presently disclosed subject matter;

FIG. 4 is a more detailed block diagram of a concealing and revealing system, according to some embodiments of the presently disclosed subject matter;

FIG. 5 is a flowchart illustration of a method of concealing message data, according to some embodiments of the presently disclosed subject matter;

FIG. 6 is a more detailed block diagram of a receiving system, according to some embodiments of the presently disclosed subject matter;

FIG. 7 is a flowchart illustration of a method of receiving revealing data, according to some embodiments of the presently disclosed subject matter;

FIG. 8 is a flowchart illustration of a method of providing revealing data, according to some embodiments of the presently disclosed subject matter;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

Embodiments of the presently disclosed subject matter relate to networks, systems, methods, and/or computer program products for messaging, including concealing data, revealing data, and/or one or more other features. In some of these embodiments the identity of a sending user of a message and/or other data is initially concealed when the (manipulated)_message or an associated created message is sent to an intended receiving user. In these embodiments, revealing data which enables determination of at least some data which the sent message concealed is only provided upon request and possibly only after a user has been authenticated as being an intended receiving user.

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures and components have not been described in detail so as not to obscure the subject matter.

As used herein, and unless explicitly stated otherwise, the phrase “for example,” “such as”, “for instance”, “e.g.”, and variants thereof describe non-limiting embodiments of the presently disclosed subject matter.

As used herein, and unless explicitly stated otherwise, the term “memory” refers to any module for storing data for the short and/or long term, locally and/or remotely. Examples of memory include inter-alia: any type of disk including floppy disk, hard disk, optical disk, CD-ROM, magnetic-optical disk, magnetic tape, flash memory, random access memory (RAM), dynamic random access memory (DRAM), static random access memory (SRAM), read-only memory (ROM), programmable read only memory (PROM), electrically programmable read-only memory (EPROM), electrically erasable and programmable read only memory (EEPROM), magnetic card, optical card, any other type of media suitable for storing electronic instructions and capable of being coupled to a system bus, a combination of any of the above, etc.

Reference in the specification to “one embodiment”, “an embodiment”, “some embodiments”, “another embodiment”, “other embodiments”, “one instance”, “some instances”, “one case”, “some cases”, “other cases” or variants thereof means that a particular feature, structure or characteristic described in connection with the embodiment(s) is included in at least one non-limiting embodiment of the presently disclosed subject matter. Thus the appearance of the phrase “one embodiment”, “an embodiment”, “some embodiments”, “another embodiment”, “other embodiments” one instance”, “some instances”, “one case”, “some cases”, “other cases” or variants thereof does not necessarily refer to the same embodiment(s).

It should be appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

Unless specifically stated otherwise, as apparent from the following discussions, it is appreciated that throughout the specification discussions utilizing terms such as “accessing”, “obtaining”, “receiving”, “deleting”, “determining”, “updating”, “performing”, “providing”, “sending”, “including”, “incorporating”, “improving”, “adding”, “modifying”, “saving”, “resending”, “reporting”, “identifying”, “forwarding” “recognizing”, “notifying”, “enabling”, “composing”, “triggering” “obtaining”, “causing”, “executing”, “allowing”, “deriving”, “using”, “handling”, “removing”, “storing”, “retrieving”, “concealing”, “revealing”, “indicating”, “authenticating”, “inputting”, “outputting”, “discarding”, “attempting”, “creating”, “manipulating”, “arranging”, “executing”, “processing”, “communicating”, “generating”, “producing”, “protecting”, or the like, refer to the action and/or processes of any combination of software, hardware and/or firmware. For example, these terms may refer in some cases to the action and/or processes of a programmable machine, that manipulates and/or transforms data represented as physical, such as electronic quantities, within the programmable machine's registers and/or memories into other data similarly represented as physical quantities within the programmable machine's memories, registers or other such information storage, transmission or display elements.

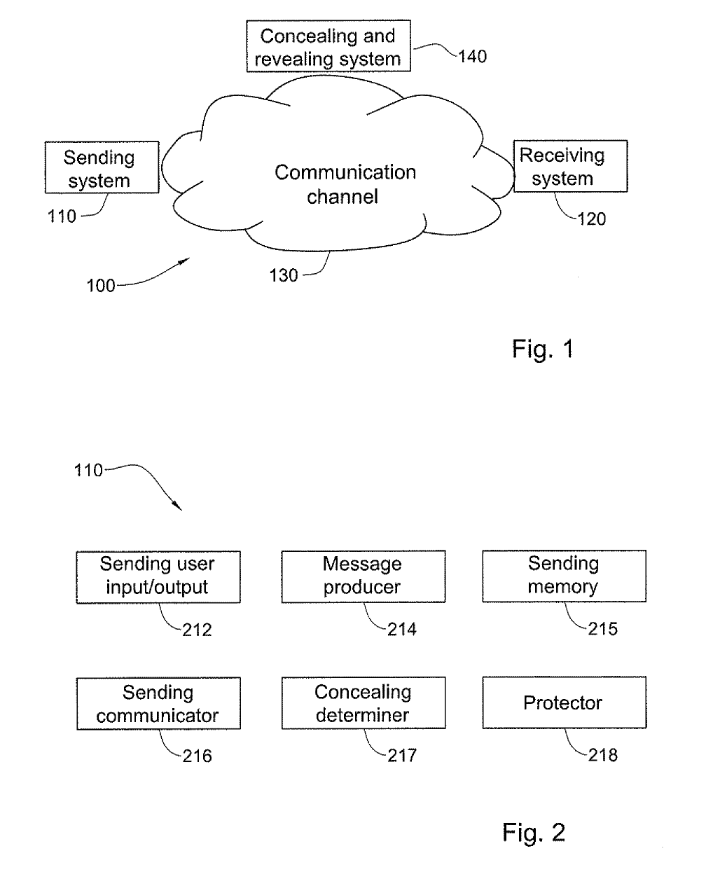

Referring now to the drawings, FIG. 1 illustrates a network 100 for messaging, according to some embodiments of the presently disclosed subject matter. In the illustrated embodiments, network 100 includes one or more sending systems 110 configured to send messages, one or more receiving systems 120 configured to receive messages, one or more concealing and revealing systems 140 configured to conceal and reveal data, and one or more communication channels 130. Embodiments of the presently disclosed subject matter do not limit the type(s) of messages transferred via network 100. Examples of types of messages include: email messages (e.g. web-based or desktop email client based), SMS, social network messages (e.g. Facebook messages, Twitter “tweets”, etc), instant messaging messages, a combination of the above, etc. Each sending system 110, receiving system 120 and/or concealing and revealing system 140 may be made up of any combination of hardware, software and/or firmware capable of performing the operations as defined and explained herein. For example, in some embodiments, any of sending system(s) 110, receiving system(s) 120 and/or concealing and revealing system(s) 140 may comprise a machine specially constructed for the desired purposes, and/or may comprise a programmable machine selectively activated or reconfigured by specially constructed program code. For simplicity of illustration and description, a single concealing and revealing system 140, a single sending system 110, a single receiving system 120, and a single communication channel 130 are illustrated in FIG. 1 and described below, but usage of the single form for any particular element should be understood to include both embodiments where there is one of the particular element in network 100 and embodiments where there is a plurality of the particular element in network 100.

Features of sending system 110 may vary depending on the embodiment. For example, in various embodiments part or all of sending system 110 may be included in a user device such as a personal computer, cell phone, smartphone, laptop, tablet computer, etc., may be included in element(s) which service multiple user devices such as proxy server(s), gateway(s), other types of servers, etc, and/or may be included in a combination of the above.

Features of concealing and revealing system 140 may vary depending on the embodiment. For example, in some embodiments, concealing and revealing system 140 may reside anywhere in network 100, whereas in other embodiments, concealing and revealing system 140 may reside in the same domain as sending system 110 and/or receiving system 120. In some embodiments, part or all of concealing and revealing system 140 may be included in a gateway, proxy server, other type of server, any other element servicing multiple user devices, etc.

Depending on the embodiment, both the functions of concealing and revealing may be attributed to the same system/module or to different systems/modules. Additionally or alternatively, depending on the embodiment, concealing may be practiced by one or a plurality of systems/modules. Additionally or alternatively, depending on the embodiment, revealing may be practiced by one or a plurality of systems/modules. Additionally or alternatively, depending on the embodiment, concealing may be practiced by module(s)/system(s) residing in sending system 110 or elsewhere. Additionally or alternatively, depending on the embodiment, revealing may be practiced by module(s)/system(s) residing in receiving system 120 or elsewhere. Therefore examples of system(s)/module(s) configured to conceal may include a single concealing and revealing system 140, a plurality of concealing and revealing systems 140, one or more concealing and revealing module(s), or concealing system(s)/module(s) which are not also configured to reveal and which reside in sending system 110 or elsewhere. Similarly, examples of system(s)/module(s) configured to reveal may include a single concealing and revealing system 140, a plurality of concealing and revealing systems 140, one or more concealing and revealing module(s), or revealing system(s)/module(s) which is/are not also configured to reveal and which reside in receiving system 120 or elsewhere. For simplicity of description and illustration, the illustrated embodiments of method 500 refer to a single concealing and revealing system 140 not residing in either sending system 110 or receiving system 120, but the subject matter described herein may be applied to other alternatives, mutatis mutandis.

Features of receiving system 120 may vary depending on the embodiment. For example, in various embodiments part or all of receiving system 120 may be included in a user device such as a personal computer, cell phone, smartphone, laptop, tablet computer, etc., may be included in element(s) which service multiple user devices such as proxy server(s), gateway(s), other types of servers, etc, and/or may be included in a combination of the above.

In some embodiments, a particular location or locations may include a sending system such as system 110 and a receiving system such as system 120 which may or may not be integrated with one another. In these embodiments, the functionality of the particular location(s) with respect to sending and/or receiving may in some cases vary for different messages. In some embodiments, additionally or alternatively a specific location or locations may include only a sending system such as system 110 or only a receiving system such as system 120. In these embodiments, the message sending or receiving functionality of the specific location(s) may in some cases be consistent for all messages.

Features of communication channel 130 may vary depending on the embodiment. For example, in various embodiments, any communication channel 130 between any pair of systems in network 100 may comprise any suitable infrastructure for network 100 that provides direct or indirect connectivity between those two systems. It is noted that the communication channel between one pair of systems in network 100 may or may not be the same as the communication channel between another pair of systems in network 100. Communication channel 130 may use for example one or more wired and/or wireless technology/ies. Examples of channel 130 include cellular network channel, personal area network channel, local area network channel, wide area network channel, internetwork channel, Internet channel, any combination of the above, etc.

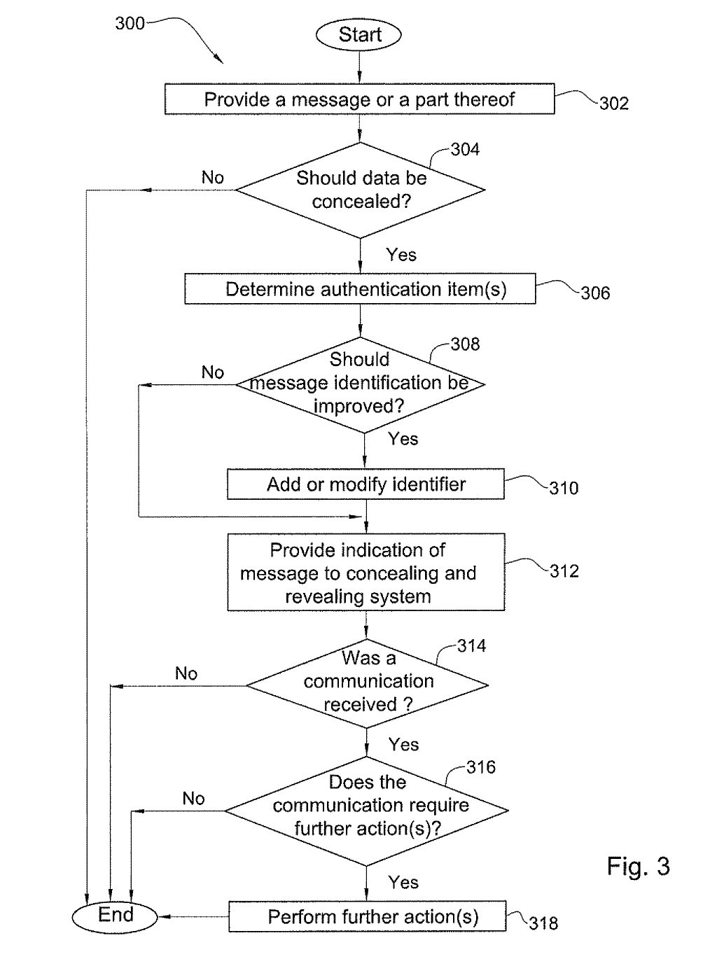

FIG. 2 is a block diagram of sending system 110, according to some embodiments of the presently disclosed subject matter. In the illustrated embodiments, sending system 110 includes a sending user input/output 212 configured to receive data from a sending user associated with sending system 110 and/or present data to a sending user associated with sending system 110, and a message producer 214 configured to produce a message (for instance using data received from a user and/or using data from other source(s) (e.g. alerts, reports, data stored in memory, etc) with or without user intervention). Optionally, sending system 110 may also include a protector 218 configured to determine identification and/or authentication item(s), a concealing determiner 217 configured to determine whether or not data in a message should be concealed, a sending memory 215 configured to store data on messages, and/or a sending communicator 216 configured to communicate via channel 130 and/or via another channel in network 100. Sending system 110 includes at least some hardware and in various embodiments, each of sending user input/output 212, message producer 214, sending memory 215, sending communicator 216, concealing determiner 217, and/or protector 218 may be made up of any combination of hardware, software and/or firmware capable of performing the operations as defined and explained herein. Examples of sending user input/output 212 include keyboard, camera, mouse, keypad, touch-screen display, microphone, speaker, non-touch-screen display, and/or printer, etc. In some embodiments any of the modules in sending system 110 may be included in any of the following: a web browser; a mail client; an instant messaging client; any other type of Internet client; a peer-to-peer application; a user interface; an SMS application; an MMS application; a user interface; a messaging application; a plug-in, an add-on, a toolbar or an applet for a browser, email client, instant messaging client or any other application; a standalone client; any other suitable element servicing one user device; a gateway; a proxy server; any other type of server; a Web service; any other suitable element servicing multiple user devices; and/or an element with any other suitable configuration, etc.

In some cases, sending system 110 may comprise fewer, more, and/or different modules than those shown in FIG. 2. Additionally or alternatively, in some cases, the functionality of sending system 110 described herein may be divided differently among the modules of FIG. 2. Additionally or alternatively, in some cases, the functionality of sending system 110 described herein may be divided into fewer, more and/or different modules than shown in FIG. 2 and/or sending system 110 may include additional, less and/or different functionality than described herein. For example, in some of these cases sending system 110 may include other module(s) for sending messages in addition to or instead of one or more of the modules illustrated in FIG. 2. As another example, additionally or alternatively in some of these cases, sending system 110 may include one or more modules of a sending system in a network with message tracking, for instance as described in co-pending U.S. application Ser. No. 12/876,384, titled “A method of guaranteeing the deliverability of emails and other messages”, which is hereby incorporated by reference herein. As another example, additionally or alternatively, in some of these cases sending system 110 may include one or more systems/modules for concealing, as will be described in more detail below.

Depending on the embodiment, modules in sending system 110 may be concentrated in one unit or separated among two or more units. Additionally or alternatively, depending on the embodiment, modules in sending system 110 may be concentrated in the same location, for instance in one unit or in various units in proximity of one another, or modules of sending system may be dispersed over various locations. For example, in some of these embodiments sending system 110 may include an embedded display or a detached display when input/output 212 includes a display. As another example, additionally or alternatively, in some of these embodiments, sending system 110 may be divided into two sub-systems, with a first subsystem including for example sending user input/output 212, message producer 214, and optionally a communicator to communicate with the second subsystem, and the second subsystem including for example sending communicator 216 and optionally concealing determiner 217, protector 218 and/or sending memory 215. In these embodiments, the two subsystems may or may not be located at the same location. As another example, additionally or alternatively, in some of these embodiments modules in sending system 110 may be divided between a plurality of elements, with certain element(s) in the plurality selected from any of the following: a web browser, an email client, an instant messaging client, a peer-to-peer application, a user interface, an SMS application, an MMS application, a messaging application, any other type of Internet client, any other suitable element servicing one user device, a gateway, a proxy server, any other type of server, a Web service, any other suitable element servicing multiple user devices, and/or an element with any other suitable configuration; and with other element(s) in the plurality selected from any of the following: an applet, toolbar, plug-in or add-on to a certain element, a standalone element associated with one user device, a gateway, a proxy server, any other type of server, a Web service, any other standalone element servicing multiple user devices, and/or a standalone element with any other suitable configuration. In these embodiments, the various elements may or may not be located at the same location.

FIG. 3 is a flowchart of a sending method 300, according to some embodiments of the presently disclosed subject matter. Method 300 may be performed in some embodiments by sending system 110. In some cases, method 300 may include fewer, more and/or different stages than illustrated in FIG. 3, the stages may be executed in a different order than shown in FIG. 3, stages that are illustrated as being executed sequentially may be executed in parallel, and/or stages that are illustrated as being executed in parallel may be executed sequentially.

In the illustrated embodiments in stage 302, a message or a part thereof is provided. For example, message producer 214 may produce a message based on user input which was received via sending user input/output 212, and/or based on data from other source(s). The message may be produced automatically, semi-automatically or manually. In this example, the produced message may be provided to sending communicator 216 or to concealing determiner 217 for additional handling once the user has indicated via sending user input/output 212 that the message should be sent, or message producer 214 has determined that the message should be sent. As another example, the provision of a part of the message may refer to the provision of the user input received via user input/output 212, and/or data from other source(s) to message producer 214 so that message producer 214 can produce the message.

In the illustrated embodiments, in optional stage 304 it is determined by sending system 110, for instance by concealing determiner 217, whether or not at least some data relating to the message should be concealed. For instance, the determination may relate to concealment of at least some data which would not be concealed if the message were sent to an intended receiving user. In some of these embodiments, the determination of whether or not to conceal relates at least to whether or not to conceal data identifying the sending user. In some other of these embodiments, the determination may relate to whether or not to conceal data not necessarily including data identifying the sending user. For example, there may be a possibility of concealing data or not concealing data. In some of these embodiments, the determination of whether or not to conceal may depend on one or more message parameters such as the message contents, the subject of the message, the sending user of the message, the intended receiving user(s), and/or any other message parameter. Still continuing with the example, in some cases, sending system 110 may store in sending memory 215 a list of receiving users whose messages should have data concealed and if the message provided in stage 302 has a receiving user which matches a receiving user on the list, then data will be concealed. It is therefore possible in some of these cases that a message may have data concealed for a particular receiving user but not for a different receiving user.

If the determination is that at least some data in the message should be concealed (yes to stage 304) then in the illustrated embodiments method 300 continues as illustrated. If the determination is that the data in the message should not be concealed (no to stage 304) then in the illustrated embodiments method 300 ends and the message production and/or sending proceeds in a known manner. In some other embodiments, if the determination is that the data in the message should not be concealed, then method 300 may proceed directly to stage 312 since in these embodiments, all messages are sent via concealing and revealing system 140 (or via any other module(s)/system(s) configured to conceal).

In some embodiments, stage 304 may be omitted, for instance if some data in any message sent by sending system 110 should be concealed (and therefore a separate determination for the current message is unnecessary), or if concealing and revealing system 140 (or any other module(s)/system(s) configured to conceal) instead makes the determination of whether or not at least some data in the message should be concealed. If stage 304 is omitted then method 300 proceeds after stage 302 to stage 306 or to a subsequent stage.

In the illustrated embodiments, in optional stage 306, sending system 110, for instance protector 218 determines identification and/or authentication item(s) for the message which would allow authentication of the receiving user and/or receiving system 120. For instance, identification and/or authentication item(s) may include a password, credentials, access token and/or decryption key. Depending on the embodiment, the identification and/or authentication item(s) may be particular to this message, or may be the same for more than one message, for instance the same for all messages with the same receiving user. Depending on the embodiment, the identification and/or authentication item(s) may be produced specifically for this message, or may be pre-existing but at this stage associated with this message. For instance, pre-existing identification and/or authentication item(s) may in some cases be item(s) which are the same for all messages with the same receiving user. Additionally or alternatively, protector 120 may optionally protect the message by performing any of the following: encryption, hashing using a one way function, digitally signing, encoding, creating a message authentication code, creating a certificate, and/or adding a specific location (e.g. Uniform Resource Locator “URL”) for validation, etc. In embodiments where stage 306 is performed, stage 306 may be performed during the initial production of the message, for instance by message producer 214 and/or during additional handling of the produced message after the user has indicated that the message be sent, for instance by concealing determiner 217. In other embodiments, stage 306 may be omitted, for instance when concealing and revealing system 140 (any other module(s)/system(s) configured to conceal) instead determines identification and/or authentication item(s) and performs any other protecting of the message, or when identification and/or authentication is not required. For instance in cases where revealing system(s)/module(s) reside(s) at receiving system 120 identification and/or authentication may or may not be required.

In the illustrated embodiments in optional stage 308, it is determined by sending system 110, for example by concealing determiner 217, whether or not message identification should be improved to facilitate communication between system 140 (or between any other module(s)/system(s) configured to conceal and/or reveal) and sending system 110. For example, stage 308 may be performed during the initial production of the message or during the additional handling after the user has indicated that the message should be sent. In other embodiments, where no message identification improvement is ever performed by sending system 110, stages 308 and 310 may be omitted. For example, in some embodiments, no message identification improvement may be performed by sending system 110 because the data provided by the sending user and/or by message producer 214 (such as body of the message, name/contact data of sending user, name/contact data of receiving user(s), name/contact data of “Reply-to” user, data/time, original message ID, and/or subject) may be sufficient to identify the message. As another example, additionally or alternatively, no message identification improvement may be performed by sending system 110, if messages provided in stage 302 always already have a satisfactory identifier located in the contents of the message. As another example, additionally or alternatively no message identification improvement may be performed by sending system 110 if concealing and revealing system 140 (or any other module(s)/system(s) configured to conceal and/or reveal) does not need to communicate with sending system 110 after stage 312.

If the determination is that the message identification should be improved (yes to stage 308), then in the illustrated embodiments in optional stage 310 a message identifier is added or modified by sending system 110, for instance by concealing determiner 217. For example, a message identifier may be generated by concealing determiner 217 and added to the message during the initial production of the message by message producer 214. As another example, where the produced message already has an identifier (such as the Message-ID of an email message), concealing determiner 217 may move or copy the existing value to a different location in the message, may modify the existing value, or may add a new identifier in addition to or instead of the existing identifier. As another example, where the produced message does not already have an identifier, concealing determiner 217 may add a message identifier to the message.

In some embodiments, the identifier added or modified in stage 310 may be unique. In other embodiments the identifier may not necessarily be unique and in some cases additional identifying information may be required to identify the message besides the identifier.

In some embodiments, an identifier added or modified in stage 310 may also serve as an indication to concealing and revealing system 140 (or to any other module(s)/system(s) configured to conceal) that at least some of the data relating to the message should be concealed. In some other embodiments (in addition to or instead of the added and/or modified identifier), sending system 110, for instance concealing determiner 217, may add to the message in stage 310 a separate indication that at least some of the data relating to the message should be concealed. For example, in some cases where an identifier is not added and/or modified by sending system 110, a separate indication of concealment may be added instead. Depending on the embodiment, the identifier or separate indication may or may not also indicate which data in the message should be concealed so as to not be disclosed to a third party. The decision of which data to conceal is not limited and depending on the embodiment may be determined based on sending user preference, receiving user preference, preference of any other interested party, policy considerations of sending system 110, of receiving system 120, and/or of concealing and revealing system 140 (or of any other module(s)/system(s) configured to conceal and/or reveal), and/or any other criteria. In still other embodiments, in some cases where an identifier is not added and/or modified by sending system 110, a separate concealment indication may not be added, for example because concealing and revealing system 140 (or any other module(s)/system(s) configured to conceal) in any event may know that all messages provided to concealing and revealing system 140 (or to any other module(s)/system(s) configured to conceal)) should have at least some data concealed, or because concealing and revealing system 140 (or any other module(s)/system(s) configured to conceal) may determine whether or not to conceal data for a particular message.

In the illustrated embodiments, if the determination is instead that the message identification should not be improved (no to stage 308) then stage 310 is skipped. For example the determination may be that message identification should not be improved by sending system 110. Continuing with this example, in some embodiments, no message identification improvement may be performed by sending system 110 because the data provided by the sending user and/or by message producer 214 (such as body of the message, name/contact data of sending user, name/contact data of “Reply-to” user, name/contact data of receiving user(s), data/time, original message ID, and/or subject) may be sufficient to identify the message. As another example, additionally or alternatively, no message identification improvement may be performed by sending system 110, if messages provided in stage 302 always already have a satisfactory identifier located in the contents of the message. As another example, additionally or alternatively no message identification improvement may be performed by sending system 110 if concealing and revealing system 140 (or any other module(s)/system(s) configured to conceal and/or reveal) does not need to communicate with sending system 110 relating to the message after stage 312.

In some embodiments prior to sending system 110 providing an indication of the message to concealing and revealing system 140 (or to any other module(s)/system(s) configured to conceal), concealing and revealing system 140 (or any other module(s)/system(s) configured to conceal) may optionally authenticate and/or identify sending system 110 and/or the sending user. For example, identification and/or authentication may be achieved by sending system 110, for instance sending communicator 216, providing the correct password, decryption key, access token, user credentials, etc. In some cases of this example, identification and/or authentication may be automatic, for instance by way of a remembered password or any other identification and/or authentication item. In other cases of this example, identification and/or authentication may be performed additionally or alternatively through input by the sending user to sending system 110 (e.g. via sending user input/output 212), for instance a password or other identification and/or authentication item. In other embodiments, identification and/or authentication may not be performed. For example identification and/or authentication may in some cases not be required if concealing and revealing system 140 (or any other module(s)/system(s) configured to conceal) is in the same domain as sending system 110, for instance if module(s)/system(s) configured to conceal reside in sending system 110.

In the illustrated embodiments, in stage 312 sending system 110, e.g. sending communicator 216, provides an indication to concealing and revealing system 140 (or any other module(s)/system(s) configured to conceal) that there is a message for intended receiving user(s). For instance, the indication may include the entire message, a part thereof, and/or other data useful to concealing and revealing system (e.g. identification and/or authentication item(s)). In some embodiments the indication which is provided at least includes data on intended receiving user(s) such as data in one or more included message receiver field(s) so that concealing and revealing system 140 (or any other module(s)/system(s) configured to conceal) may provide a message to the intended receiving user(s). For example, in an email message, receiver field(s) may include the “To” field and/or equivalent, the “CC” field and/or equivalent, and/or the “BCC” field and/or equivalent.

In some embodiments, sending system 110 only provides the indication to concealing and revealing system 140, if a message that will be sent by concealing and revealing system 140 (or by any other module(s)/system(s) configured to conceal) to receiving system 120 will at least conceal some of the message data (e.g. at least the identity of the sending user). In these embodiments therefore the providing of a message to concealing and revealing system 140 may indicate to concealing and revealing system 140 (or to any other module(s)/system(s) configured to conceal) that at least some data relating to the message should be concealed in a message sent by concealing and revealing system 140 (or by any other module(s)/system(s) configured to conceal) to an intended receiving user. In other embodiments, where sending system 110 determines which messages should have at least some data concealed, but nevertheless provides messages to concealing and revealing system 140 (or to any other module(s)/system(s) configured to conceal) which should not necessarily have related data concealed by concealing and revealing system 140 (or by any other module(s)/system(s) configured to conceal), an indicator in a message, which may be for instance the added or modified identifier described in stage 310 or a separate concealment indication, may inform concealing and revealing system 140 (or any other module(s)/system(s) configured to conceal) that at least some of the data relating to the message should be concealed.

In some embodiments, the same message may be intended for a plurality of intended receiving users. In some embodiments with a plurality of intended receiving users where stage 306 and/or 310 is performed, stage 306 and/or 310 may be repeated for each intended receiving user (or for each group of intended receiving users) so that if identification and/or authentication item(s) is/are determined and/or an identifier is to be added/modified, the determination and/or addition/modification may be different for each intended receiving user (or for each group). In some cases of these embodiments, in stage 312, data which is to be included in the indication and which is not the same for all receiving users (e.g. any of the following: identification and/or authentication item(s), identifier, corresponding receiving user(s), etc) may be provided to concealing and revealing system 140 (or to any other module(s)/system(s) configured to conceal) a plurality of times but any other data of the indication which is to be provided to concealing and revealing system 140 (or to any other module(s)/system(s) configured to conceal) may need to only be provided once to concealing and revealing system 140. In other cases of these embodiments, all data of the indication which is to be provided to concealing and revealing system 140 (or to any other module(s)/system(s) configured to conceal) may be provided to concealing and revealing system 140 (or to any other module(s)/system(s) configured to conceal) a plurality of times in stage 312 in accordance with the number of intended receiving users (or in accordance with the number of groups of intended receiving users). In other embodiments, with a plurality of intended receiving users, stage 306 and/or 310 may not necessarily be repeated for each receiving user (or for each group of receiving user). For example, the procedures performed by concealing and revealing system 140 (or by any other module(s)/system(s) configured to conceal) for all of the intended receiving users may be uniform. In these embodiments, stage 312 may not necessarily include a plurality of times that the same and/or different data is provided to concealing and revealing system 140 (or to any other module(s)/system(s) configured to conceal).

Although, as mentioned above, the illustrated embodiments assume that an indication is provided in stage 312 to system(s)/module(s) configured to conceal (e.g. concealing and revealing system 140) which is external to sending system 110, in embodiments where the concealing functionality resides in sending system 110, the indication may be provided in stage 312 to the module(s)/system(s) in sending system 110 which are configured to conceal data. Depending on the embodiment where concealing functionality resides in sending system 110, the remaining stage(s) of method 300 may or may not be omitted. For instance, in some embodiments where the remaining stages may be performed, the remaining stages may refer to a communication received from concealing module(s)/system(s) residing in sending system 110 or received from separate revealing module(s)/system(s) (which may be external to or internal to receiving system 120).

Depending on the embodiment, data on the message may or may not be stored by sending system 110, for example in sending memory 215. The storage, if occurring, may occur before, after, or in parallel with providing stage 312. Depending on the embodiment with storing, the stored data may include all data relating to the message or only some of the data relating to the message. For example in instances where only some of the data relating to the message is stored, the stored data may include any of the following: identifier, identification and/or authentication item(s), data in one or more included message receiver field(s) such as receiving user(s) contact information and/or name, data in subject field and/or equivalent, data in date/time field and/or equivalent, etc. In some of these embodiments, data may be stored in case a communication is later received from concealing and revealing system 140 (or from any other module(s)/system(s) configured to conceal and/or reveal). For instance, sending system 110 may store and/or may be capable of modifying (e.g. updating) and/or generating on the fly appropriate data in order to be able to respond to a request from concealing and revealing system 140 (or from any other module(s)/system(s) configured to reveal) for revealing data relating to the message. Examples of appropriate data may include any of the following: data to identify the message, identification and/or authentication item(s), data which a message to the receiving user concealed, etc. Examples of revealing data may include data which enables the determination of some or all of the data which a message concealed. Depending on the example, revealing data which enables the determination of particular concealed data may or may not be identical to the particular concealed data.

Additionally or alternatively, for instance, sending system 110 may store sufficient data in order to identify the message, including for example an identifier, in case concealing and revealing system 140 (or any other module(s)/system(s) configured to conceal and/or reveal) provides a “feedback” communication such as relating to sending of a message to the receiving user, and/or relating to the revealing of data which was initially concealed from the receiving user.

In the illustrated embodiments, in optional stage 314 it is determined by sending system 110, whether or not a communication was received regarding the message from concealing and revealing system 140 (or from any other module(s)/system(s) configured to conceal and/or reveal). For instance, if a communication would have been received via channel 130 or via a different network channel then sending communicator 216 may make the determination. For example, in some cases a communication may be received if and when concealing and revealing system 140 (or any other module(s)/system(s) configured to reveal) requires data from sending system 110 in order to service a request from receiving system 120 for revealing data. As another example, a received communication may indicate that concealing and revealing system 140 (or any other module(s)/system(s) configured to conceal) sent the message to the receiving user and/or may include the sent message. As another example, additionally or alternatively, a received communication may relate to successful provision of revealing data to receiving system 120. As another example, additionally or alternatively, a received communication may indicate that a predetermined time has elapsed between the message being sent without a request for data, may request alternate contact information for resending the message and/or may indicate that the message has been resent. As another example, the communication may be a reply from the receiving user. If no communication is received from concealing and revealing system 140 (or any other module(s)/system(s) configured to conceal and/or reveal) relating to the message (no to stage 314) then method 300 ends.

In embodiments where no communications would be provided to sending system 110 by concealing and revealing system 140 (or by any other module(s)/system(s) configured to conceal and/or reveal) stage 314 may be omitted.

In the illustrated embodiments in optional stage 316, it is determined by sending system 110, for example by sending communicator 216, if the received communication requires further action(s). If not (no to stage 316), then method 300 ends.

If instead a communication has been received which necessitates further action(s) (yes to stage 316), then in the illustrated embodiments in optional stage 318, further action(s) is/are taken. For instance, if the communication relates to data that should be stored and/or reported then data may be saved by sending system 110, e.g. to sending memory 215, and/or data may be reported by sending system 110 to the sending user, e.g. via sending user input/output 212. In some cases of this instance, the data to be stored/reported may include any data including, for example, an indication that a message was sent to an intended receiving user which concealed data, the message sent to an intended receiving user, an indication that revealing data was provided to receiving system 120, an indication that a predetermined time has elapsed after sending the message without receiving a request for data, an indication that a message was resent and any modifications made to the resent message, a reply, etc.

Additionally or alternatively, for instance, the further action(s) may include providing data including stored data (e.g. from sending memory 215) and/or including data generated and/or modified on the fly (e.g. by protector 218 and/or message producer 214) and providing the data to concealing and revealing system 140 (or to any other module(s)/system(s) configured to reveal), e.g. by sending communicator 216. In various cases of data provision, identification and/or authentication may or may not be performed by sending system 110 prior to retrieving stored data, generating data and/or modifying data (in addition to or instead of any identification and/or authentication performed by concealing and revealing system 140 or by any other module(s)/system(s) configured to reveal). In some cases where identification and/or authentication is performed by sending system 110 prior to data provision, sending system 110 may check if the identification and/or authentication item(s) provided by receiving system 120 to concealing and revealing system 140 (or to any other module(s)/system(s) configured to reveal) and then from concealing and revealing system 140 (or from any other module(s)/system(s) configured to reveal) to sending system 110 match the message identification and/or authentication item(s) (which for example may have been stored in sending memory 215 and/or generated and/or modified on the fly). Additionally or alternatively, for instance, the further action(s) may include providing alternate contact information for resending a message if a predetermined time has elapsed after sending the message without receiving a request for data such as revealing data, etc.

In embodiments where no communications which require further action(s) would be provided to sending system 110 by concealing and revealing system 140 (or by any other module(s)/system(s) configured to conceal and/or reveal), stages 316 and 318 may be omitted.

After stage 318, in the illustrated embodiments method 300 ends.

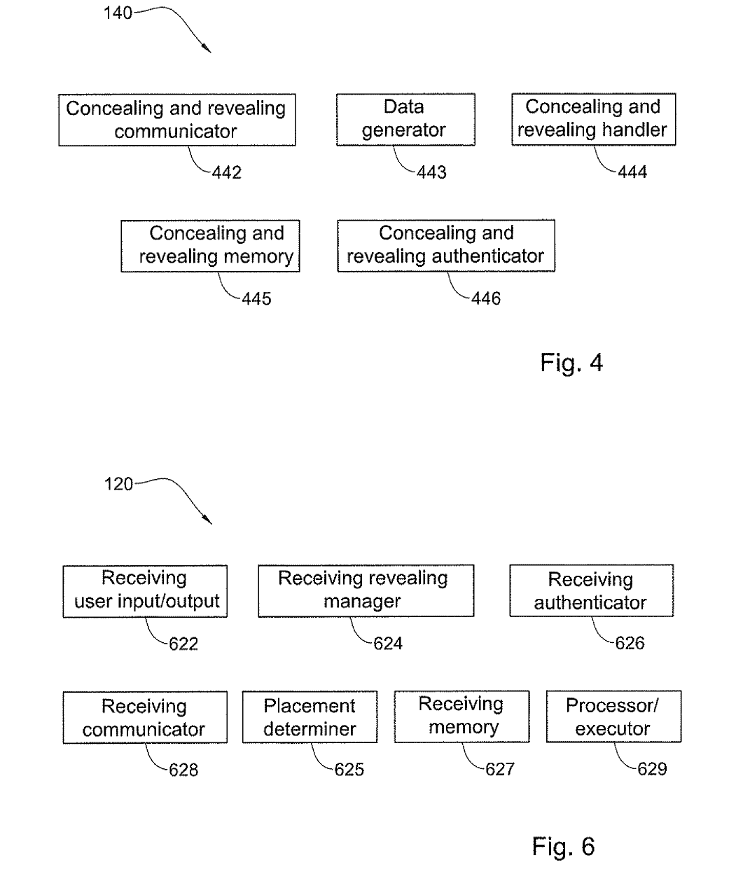

FIG. 4 is a block diagram of concealing and revealing system 140, according to some embodiments of the presently disclosed subject matter. In the illustrated embodiments, concealing and revealing system 140 includes a concealing and revealing communicator 442 configured to communicate via channel 130 and/or via another channel in network 100, and a concealing and revealing handler 444 configured to handle concealing and/or revealing of data Optionally concealing and revealing system 140 may also include a concealing and revealing authenticator 446 configured to authenticate and/or identify sending systems, sending users, receiving systems and/or receiving users, a concealing and revealing memory 445 configured to store data relating to messages, and/or a data generator 443 configured to generate and/or modify data. In various embodiments, each of concealing and revealing communicator 442, data generator 443, concealing and revealing handler 444, concealing and revealing memory 445 and/or concealing and revealing authenticator 446 may be made up of any combination of hardware, software and/or firmware capable of performing the operations as defined and explained herein.

In some cases, concealing and revealing system 140 may comprise fewer, more, and/or different modules than those shown in FIG. 4. Additionally or alternatively, in some cases, the functionality of concealing and revealing system 140 described herein may be divided differently among the modules of FIG. 4. Additionally or alternatively, in some cases, the functionality of concealing and revealing system 140 described herein may be divided into fewer, more and/or different modules than shown in FIG. 4 and/or concealing and revealing system 140 may include additional, less and/or different functionality than described herein. For example, concealing and revealing system 140 may include other module(s) for concealing and/or revealing data in addition to or instead of one or more of the modules illustrated in FIG. 4. As another example, concealing and revealing system 140 may additionally or alternatively include module(s) unrelated to concealing and revealing data in addition to or instead of one or more of the modules illustrated in FIG. 4. Continuing with this example, in some instances concealing and revealing system 140 may include one or more modules of a tracking system in a network with message tracking, for instance as described in the aforementioned U.S. application Ser. No. 12/876,384.

Depending on the embodiment, modules in concealing and revealing system 140 may be concentrated in one unit or separated among two or more units. Additionally or alternatively, depending on the embodiment, modules in concealing and revealing system 140 may be concentrated in the same location, for example in one unit or in various units in proximity of one another, or modules of concealing and revealing system 140 may be dispersed over various locations. For example, in some embodiments, there may be one or more concealing systems/modules separate from one or more revealing systems/modules. In some cases of this example, there may be separate communicators, separate data generators, separate handlers, separate memories, and/or separate authenticators in the separate concealing system(s)/module(s) and revealing system(s)/module(s). Additionally or alternatively, in some cases of this example, one or more of the modules illustrated in FIG. 4 may be included in either the separate concealing system(s)/module(s) or separate revealing system(s)/module(s). Additionally or alternatively in this example, the separate concealing system(s)/module(s) may reside in sending system 110 and/or elsewhere in network 100, and the separate revealing system(s)/module(s) may reside in receiving system 120 and/or elsewhere in network 100. In some cases of this example the communication between separate concealing system(s)/module(s) and revealing system(s)/modules may or may not include an exchange of encryption/decryption secrets (or keys) and/or mutual authentication.

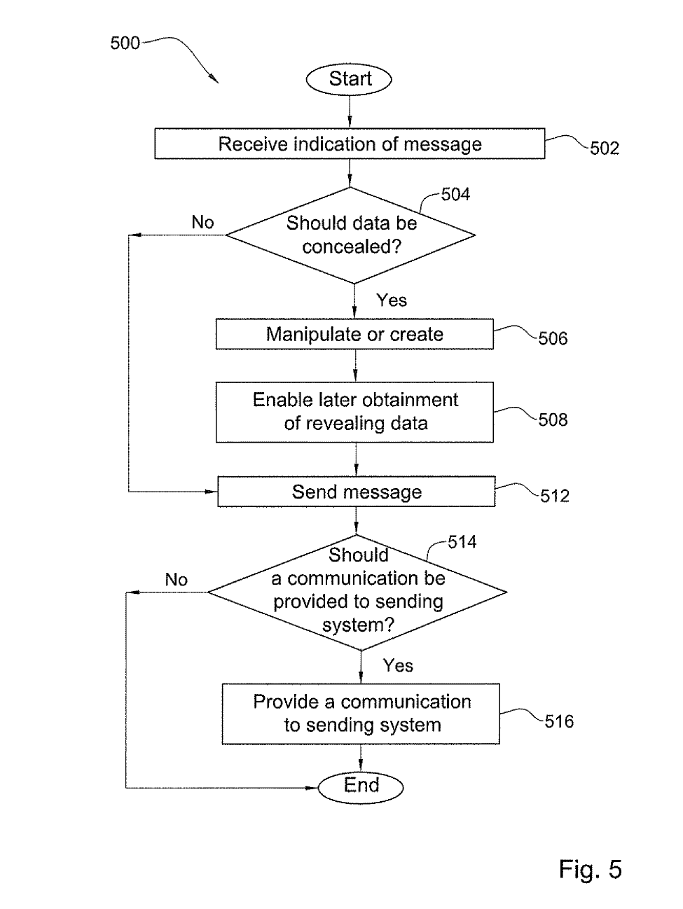

FIG. 5 is a flowchart of a method 500 of concealing message data, according to some embodiments of the presently disclosed subject matter. Method 500 may be performed in various embodiments by any system(s)/module(s) configured to conceal. Examples of such system(s)/module(s) may include a single concealing and revealing system 140, a plurality of concealing and revealing systems 140, one or more concealing and revealing module(s), or (separate) concealing system(s)/module(s) which is/are not also configured to reveal. (In embodiments with separate concealing system(s)/module(s), the separate concealing system(s)/module(s) may or may not reside in sending system 110). For simplicity of description and illustration, the illustrated embodiments of method 500 refer to a single concealing and revealing system 140.

In some cases, method 500 may include fewer, more and/or different stages than illustrated in FIG. 5, the stages may be executed in a different order than shown in FIG. 5, stages that are illustrated as being executed sequentially may be executed in parallel, and/or stages that are illustrated as being executed in parallel may be executed sequentially.

In the illustrated embodiments in stage 502, concealing and revealing system 140, for example concealing communicator 442 (or any other module(s)/system(s) configured to conceal), receives indication of a message. The disclosed subject matter does not impose limitations on the indication received in stage 502.

For example, in some embodiments the entire message or a part thereof may be received and serve as an indication of a message from sending system 110. In some of these embodiments, the message or a part thereof which is received at least includes data on intended receiving user(s) such as data in one or more included message receiver field(s) so that concealing and revealing system 140 (or any other module(s)/system(s) configured to conceal) may provide a message to the intended receiving user(s).

In some embodiments, prior to stage 502, concealing and revealing system 140, for instance concealing and revealing authenticator 446, (or any other module(s)/system(s) configured to conceal) may optionally authenticate and/or identify sending system 110 and/or the sending user. For example, identification and/or authentication may be achieved by checking that sending system 110 provides the correct password, decryption key, access token, user credentials, etc. In some cases of this example, identification and/or authentication may be automatic, for instance by way of a remembered password or any other identification and/or authentication item. In other cases of this example, identification and/or authentication may be performed additionally or alternatively through input by the sending user, for instance a password or other identification and/or authentication item. In other embodiments, identification and/or authentication may not be performed. For example identification and/or authentication may in some cases not be required if the system(s)/module(s) configured to conceal resides in is in the same domain as sending system 110, for instance residing in sending system 110.

In the illustrated embodiments, in optional stage 504, concealing and revealing system 140, for instance concealing and revealing handler 444 (or any other module(s)/system(s) configured to conceal) determines whether or not a message that conceals data should be sent to a receiving user. For example, an identifier modified or added in stage 310 by sending system 110 may indicate that a message should be sent that conceals data. Additionally or alternatively in another example a separate concealment indication added by sending system 110 may indicate that a message should be sent that conceals data. In another example concealing and revealing system 140 (or any other module(s)/system(s) configured to conceal) may additionally or alternatively determine whether or not a message should be sent that conceals data based on an analysis of data received in stage 502. This analysis may substitute for a determination by sending system 110 on whether or not to conceal data, or may supplement and possibly overrule a determination by sending system 110. Continuing with this example, concealing and revealing system 140 (or any other module(s)/system(s) configured to conceal) may decide whether or not a message should be sent that conceals data depending on one or more message parameters such as the message contents, the subject of the message, the sending user of the message, the intended receiving user(s), and/or any other message parameter. Still continuing with the example, in some cases, concealing and revealing system 140 (or any other module(s)/system(s) configured to conceal) may store in memory (e.g. memory 445) a list of receiving users and/or sending users whose messages should have data concealed and if the sending user and/or receiving user of the message for which an indication was received in stage 502 matches the receiving user and/or sending user on the list, then it may be decided to provide a message that conceals data. It is therefore possible in some of these cases that a message sent by concealing and revealing system 140 (or by any other module(s)/system(s) configured to conceal) will have data concealed for a particular receiving user but not for a different receiving user.

In the illustrated embodiments, if the determination is that a message should be sent that conceals data (yes to stage 504) then method 500 continues to stage 506. In the illustrated embodiments, if instead the determination is that a message should be sent that does not conceal data (no to stage 504), then method 500 jumps to stage 512.

In other embodiments, stage 504 may be omitted. For example, in some of these embodiments an indication of a message would only have been received in stage 502 if a message should be sent that conceals data. In these embodiments assuming an indication has been received in stage 502, a separate determining stage may in some cases be considered unnecessary.

In the illustrated embodiments, in stage 506, concealing and revealing system 140, for instance concealing and revealing handler 444 (or any other module(s)/system(s) configured to conceal) manipulates received data into a message that will be sent out, or creates a new message that will be sent out. Therefore in several of these embodiments, the sent out message may be considered to still be the message whose indication was received in stage 502, or may be considered to be a separate message which is associated with the message whose indication was received in stage 502. In some of these embodiments, the manipulation or creation, which results in the message to be sent out to an intended receiving user, may conceal at least some data which would not be concealed if the produced message (whose indication was received in stage 502) were additionally or alternatively sent to that intended receiving user (for instance by sending system 110). For instance, in some cases of these embodiments the message to be sent out may at least conceal the identity of the sending user, whereas in other cases the message to be sent out may not conceal the identity of the sending user but may conceal other data. Depending on the embodiment, the decision of which data to conceal (so as not to be disclosed to a third party) is not limited and depending on the embodiment may be determined based on sending user preference, receiving user preference, preference of any other interested party, policy considerations of sending system 110, receiving system 120, and/or concealing and revealing system 140 (or any other module(s)/system(s) configured to conceal and/or reveal, and/or any other criteria. Additionally or alternatively, depending on the embodiment, sending system 110 may have indicated which data should be concealed or concealing and revealing system 140 (or any other module(s)/system(s) configured to conceal) may determine which data should be concealed.

It is noted that in some cases of these embodiments, a message that is sent out may be considered to conceal particular data if the system which receives the message (e.g. receiving system 120, message managing system such as a webmail operator system, or a part thereof, etc.) cannot deterministically determine the particular data from the message without further communication with revealing system(s)/module(s) such as system 140 In some of these cases, even after receiving an unlimited number of messages, the receiving system may not be able to deterministically determine concealed data from those messages without further communication with revealing system(s)/module(s) such as system 140. However, in other cases of these embodiments, a message may be considered to conceal particular data under additional and/or other conditions.

The manipulation of received data, for instance may include the manipulation of a message or a part thereof which was received as the indication in stage 502. Manipulation of received data may include any appropriate operations such as adding, modifying, substituting, hiding, and/or deleting, etc. It is noted that deleted (AKA or removed) data will not be in the message that is sent out, but depending on the example, deleted data may be saved and capable of being retrieved and/or modified, deleted data may be capable of being regenerated, and/or deleted data may be discarded completely. In some examples, for instance, manipulating the received data may include removing any trace of the sending user or sending system 110 from the message that will be sent out, such as any of the following: deleting data in the “From” field and/or equivalent, deleting data which would have enabled the receiving user to reply to the sending user, deleting data which specifies the path taken by the received data from sending system 110 to concealing and revealing system 140 (or to any other module(s)/system(s) configured to conceal), including for instance server(s) passed, etc. In some of these examples of manipulation, data may be added or substituted in the “From” field (and/or equivalent) and/or in the “reply to” information. For instance, after manipulation, the data in the “From” field may be in some cases of these examples allow receiving system 120 to determine the contact information of concealing and revealing system 140 (or of any other module(s)/system(s) configured to reveal) as will be explained in more detail below with reference to method 700. Additionally or alternatively for instance, a “Reply to” indicator, which in some cases of these examples may be added or substituted in “Reply to” information, may allow a reply provided by receiving system 120 to system 140 (or of any other module(s)/system(s) configured to reveal) to be forwarded to the sending user.

In some embodiments, the indication received in stage 502 may at least have included data on intended receiving user(s) such as data in one or more included message receiver field(s). In some of these embodiments, assuming manipulation of the received data into the message to be sent out, data on intended receiving user(s) may be retained or modified in a way which will still allow the sent message to reach intended receiving user(s). Additionally or alternatively, in some embodiments, the indication received may have included any of the following: data in one or more other fields, data in the body of the message, the added or modified identifier, a separate concealment indication, etc.

Assume embodiments where the indication included data in the subject field and/or equivalent and/or data in the body of the message, and that received data will be manipulated into a message to be sent out. In these embodiments manipulating the received data may or may not include removing some or all of the data in the “Subject” field (and/or equivalent) and/or in the message body. In some of these embodiments, the data received may not necessarily include the actual subject matter and/or body of the message, but perhaps may includes a generic and/or empty subject field and/or message body which would not necessarily need to be removed. In other of these embodiments, additionally or alternatively, the data received may include the actual subject matter and/or message body, but for any appropriate reason the subject matter and/or body of the message may not necessarily be removed. In some of these embodiments, additionally or alternatively manipulating may or may not include modifying data in the subject field (and/or equivalent) and/or in the message body. In some of these embodiments, additionally or alternatively, manipulating may or may not include adding or substituting data to the subject field (and/or equivalent) and/or to the message body. For example, in some cases of these embodiments data added, substituted and/or modified in the subject field and/or equivalent and or in the message body may render the subject matter and/or message body generic. A subject matter and/or message body may be considered to be generic if the subject matter and/or message body are not related in any way to a specific sending user or receiving user and in particular not related in any way to the actual sending user and receiving user of the message. Continuing with this example, in some of these cases, a generic subject matter and/or message body may include an explanation that the message conceals data and/or how the data may be revealed. Additionally or alternatively, after manipulation, the subject field (and/or equivalent), the message body, and/or elsewhere in the message may include a reference as will be discussed below.

Assume embodiments where the indication received in stage 502 additionally or alternatively included data in the date/time field and/or equivalent, an identifier and/or separate concealment indication and that received data will be manipulated into a message to be sent out. In these embodiments, manipulating the received data may or may not include removing the date/time, identifier and/or separate concealment indication. In some of these embodiments, if the date/time, identifier, and/or concealment indication does not indicate the sending user, sending system 110 and/or other data which should not be disclosed to a third party, then the date/time, identifier, and/or concealment indication may not necessarily be concealed. Additionally or alternatively, in some of these embodiments, if the date/time, identifier, and/or concealment indication may assist the receiving system 120 in requesting revealing data (for example as in method 700 described below), then the data which may be of assistance, may not necessarily be concealed. In some of these embodiments, additionally or alternatively, manipulating may or may not include modifying, substituting, and/or adding date/time field (and/or equivalent) data, an identifier and/or separate concealment indication.

In some embodiments, creating a new message may include for instance, creating a message which conceals the sending user, sending system 110, and/or other data which should not be disclosed to a third party. In some of these embodiments, the data in the “From” field and/or Reply-To information in the created message may not allow receiving system 120 to detect the sending user or sending system 110. For instance, the data in the “From” field of the created message may in some cases allow receiving system 120 to determine instead the contact information of concealing and revealing system 140 (or of any other module(s)/system(s) configured to reveal). Additionally or alternatively for instance, a “Reply-To” indicator in the created message may in some cases instead allow receiving system 120 to provide a reply to system 140 (or to any other module(s)/system(s) configured to reveal) which will be forwarded to the sending user. In some embodiments of message creation, the indication received in stage 502 may have at least included data on intended receiving user(s) such as data in one or more included message receiver field(s). In some of these embodiments, message creation may include creating a message intended for those receiving user(s). Additionally or alternatively, in some embodiments, message creation may include composing data in one or more other fields, data in the body of the message, etc.

In some of these embodiments, some or all of the composed data may be may be the equivalent of, may include, or may be based on, data received as the indication in stage 502. Additionally or alternatively, in some of these embodiments, some or all of the composed data may not be the equivalent of, may not include, and may not be based on received data. For example, as described below, in cases where a reference and/or concealment indication in the created message may assist the receiving system 120 in requesting revealing data (for example as in method 700 described below), the reference and/or concealment indication in the created message may or may not be the equivalent of, include, or be based on, a received identifier and/or concealment indication, respectively. Continuing with the example, in some of these cases, the subject field (and/or equivalent), the message body and/or elsewhere in the created message may include the reference. In another example, additionally or alternatively, the subject matter in the subject field (and/or equivalent), the body of the message, and/or data in the time/date field of the created message, may or may not be the equivalent of, include, or be based on, a received subject matter, body of the message and/or time/date respectively. Continuing with the example, if a generic subject matter (and/or message body) was received in stage 502, then in some cases the subject matter (and/or message body) in the created message may be more likely to be the equivalent of, include, or be based on the received subject matter (and/or message body), than if the actual subject matter (and/or message body) was received in stage 502 or than if an empty or no subject matter (and/or message body) was received in stage 502. However, it is possible that if the actual subject matter (and/or message body) was received in stage 502, or if an empty or no subject matter (and/or message body) was received in stage 502, the subject matter (and/or message body) in the created message may still in some cases be the equivalent of, include, or be based on the received subject matter (and/or message body). Continuing with this example, in some of these cases a generic subject field and/or message body in the created message may include explanation that the message conceals data and/or how the data may be revealed.

In the illustrated embodiments in stage 508, concealing and revealing system 140 (or of any other module(s)/system(s) configured to conceal) enables subsequent obtainment of (revealing) data that will enable determination of some or all of the data that the message that will be sent out conceals. Depending on the embodiment the revealing data that that may subsequently be obtained may or may not at least enable the determination of the identity of the sending user of the message whose indication was received in stage 502.

In some of these embodiments, enabling subsequent obtainment may include concealing and revealing system 140, for instance handler 444, (or any other module(s)/system(s) configured to conceal) ensuring that the message that will be sent out includes data which may be used by receiving system 120 in requesting revealing data, for example as will be described below in method 700.

For instance in some cases receiving system 120 may use data in the “From” field or equivalent of the message. In some of these cases, it may therefore be ensured that this field includes an indicator of concealing and revealing system 140 (or of any other module(s)/system(s) configured to reveal) which may be used by receiving system 120 in determining direct contact information of concealing and revealing system 140 (or of any other module(s)/system(s) configured to reveal). For example, concealing and revealing system 140 may be indicated as “service@concealing-system.com”.

Additionally or alternatively, in some cases, receiving system 120 may use data from message receiver field(s). In some of these cases, identifying information of the receiving user(s) such as receiving user(s) contact information and/or name may be specified in a request from receiving system 120 in order to receive revealing data for a particular message, revealing data for all messages for a receiving user, or revealing data for all messages for a receiving user not previously provided to the receiving user. Therefore in these cases, it may be ensured that the message receiver field(s) includes such identifying information.

Additionally or alternatively, in some cases, any data in the message may be used by receiving system 120 when providing the request, including any of the following: the body of the message, data in the “date/time” field and/or equivalent such as date/time sent and/or received, data in the “subject” field and/or equivalent, all data which was comprised in the message, etc. Therefore in some of these cases, it may be ensured that data which may be used is included in the message.

Additionally or alternatively, in some cases receiving system 120 may use a reference when providing the request. Therefore in some of these cases, it may be ensured that the message includes a reference. Although herein the term “reference” appears in the single form for simplicity of description, it should be evident that in some embodiments multiple references may be included in the message, and similar systems and methods to those described herein may be used, mutatis mutandis.

In some examples where the message includes a reference, the reference is unique to the message. In other examples the reference is not necessarily unique and in some of these examples receiving system 120 may need to use additional identifying information in requesting revealing data. In still other examples, the reference is not necessarily unique but may relate to a plurality of messages and in some of these examples, receiving system 120 may use the same reference to request revealing data relating to a plurality of messages. In some examples where the message includes a reference, if the same message is to be sent to a plurality of intended receiving users, the reference in the message may be different for each receiving user. In other examples, for a plurality of receiving users, the reference may not necessarily be different for each receiving user. For instance, in some of these other examples, identification and/or authentication item(s) for all possible receiving users may be stored in memory (in sending system 110 and/or concealing and revealing system 140, and/or in any other module(s)/system(s) configured to conceal and/or reveal) as corresponding to the message, or all receiving users may share the same identification and/or authentication item(s), and therefore the reference may be the same for all copies of the message. As another example a group of two or more receiving users may share identification and/or authentication item(s) (or identification and/or authentication items for all of receiving users in this group may be stored in memory as corresponding to a message) and therefore the reference may be the same for all receiving users in this group. As another example, knowledge of which receiving user is requesting concealed data may be obtained otherwise (for example because a request for retrieval includes information on the receiving user) and therefore the reference does not need to be unique for each receiving user.

In some examples where the message includes a reference, the reference may be a pointer which is associated with a resource and specifies the location where the resource is available and optionally also specifies the resource and/or means to retrieve the resource. The pointer, in some instances may include a Uniform Resource Locator “URL” (e.g. address of webpage) or other location indication and may also include parameters regarding the communication method or protocol to be used to retrieve data. Additionally or alternatively, in some examples where the message includes a reference, the reference may be a code associated with the resource, but which may not completely specify the location of the resource. In these examples, receiving system 120 may need to determine or know where to provide a request for revealing data. For instance, receiving system 120 may in some cases determine the location where to provide by looking up at least part of the code and/or data in the “From” field or equivalent in a look-up table which cross references the code or data in the “From” field, or a part thereof, with the location of concealing and revealing system 140 (or of any other module(s)/system(s) configured to reveal). In some of these cases the code may include an indicator of concealing and revealing system 140 (or of any other module(s)/system(s) configured to reveal). Alternatively or additionally, receiving system 120 may in some cases know the location of concealing and revealing system 140 (or of any other module(s)/system(s) configured to reveal) and therefore where to provide even without looking up a look up table or may determine where to provide based on predetermined policy (as will be explained in more detail with reference to method 700).

In some examples where the indication received in stage 502 included a message identifier and the message that will be sent out will include a reference, the reference may be the equivalent of, may include, or may be based on a received identifier, whereas in other examples the reference may not necessarily be related to the identifier. In various cases the reference may be included in the Subject field or equivalent, in receiver field(s), in “From” field and/or equivalent, in “Reply-To”, in “Date/Time Sent” field and/or equivalent, in the body of the message, and/or anywhere else in the message that will be sent out. In some of these cases, the reference may be included in one or more of the message header fields whose data is slated to be presented to a receiving user in a message list. Examples of message lists include inter-alia (summary) inbox message list, priority message list, message folder, deleted items folder, etc. For example, assuming that a message list includes data from header field(s) such as one or more message receiving user field(s), a “From” field and/or equivalent, a “Subject” field and/or equivalent, and/or a “Date/Time” field and/or equivalent, the reference may be located in one or more of the included receiving user field(s), “From” field and/or equivalent, “Subject” field and/or equivalent, and/or “Date/Time” field and/or equivalent.

In some embodiments, enabling subsequent obtainment may additionally or alternatively include concealing and revealing system 140, for instance handler 444 (or of any other module(s)/system(s) configured to conceal), ensuring that receiving system 120 will realize that the message conceals data. In some of these embodiments a reference and/or data in the “From” field or equivalent of the message may also serve as an indication that the message conceals data to receiving system 120. For instance assuming that concealing and revealing system 140 (or any other module(s)/system(s) configured to conceal) only sends messages that conceal data, receiving system 120 may realize that concealing and revealing system 140 (or any other module(s)/system(s) configured to conceal) is indicated in the “From” field or equivalent and therefore the message conceals data. Additionally or alternatively in another instance, receiving system 120 may know from the presence, format and/or content of the reference that the message conceals data. In some other embodiments (in addition to or instead of the reference and/or data indicating system 140 or any other module(s)/system(s) configured to reveal), concealing and revealing system 140, for instance handler 444, (or any other module(s)/system(s) configured to conceal) may include in the message a separate indication that the message conceals data. The separate indication, if included, may be included in one or more of the header fields of the message whose data is slated to be presented to a receiving user in a message list or may be included elsewhere in the message, depending on the example. If a concealment indication was received in stage 502, then depending on the example where a separate indication is included in the message that will be sent out, the included separate indication may or may not be the equivalent of, include, or be based on the received concealment indication. In some other embodiments, system 140 (or any other module(s)/system(s) configured to conceal) may not need to ensure that receiving system 120 will realize that the message conceals data because receiving system 120 may know (even without checking the “From” field, the reference and/or for a separate indication) that all received messages conceal data, for instance because the receiving user has so requested.

It is noted that data which is slated to be presented in a message list may or may not at the end be presented in the message list to the receiving user. For example, depending on the embodiment, the reference and/or separate indication of concealment may or may not be presented to the receiving user (or may only initially be presented to the receiving user). For instance, receiving system 120 may in some cases of this example remove or hide the reference and/or separate indication as will be explained in more detail below. In another example, additionally or alternatively, in some embodiments data which is slated to be presented in a message list may be presented in addition to or instead in another view such as the individual message view. It is also noted that depending on the particular receiving system 120 which corresponds to the receiving user, different data may be considered to be slated to be presented in a message list. For example a receiving system 120 associated with an email client may in some cases present more data in a message list to a receiving user than the data presented in a message list to a receiving user associated with a message managing system of a webmail operator. Therefore in some embodiments where it is desirable to include the reference, and/or separate indication in data slated to be presented in a message list, if concealing and revealing system 140 (or any other module(s)/system(s) configured to conceal) is not necessarily aware of the receiving arrangement for a particular receiving user, concealing and revealing system 140 (or any other module(s)/system(s) configured to conceal) may add a reference, and/or separate indication to one or more of the header fields of the message which in most or all receiving arrangements would be slated to be presented to the receiving user in a message list.

In some embodiments, enabling subsequent obtainment may additionally or alternatively include concealing and revealing system 140, for instance authenticator 446, (or any other module(s)/system(s) configured to conceal) determining identification and/or authentication item(s) for the message which will be sent out. Depending on the embodiment, the identification and/or authentication item(s) may be particular to this message, or may be the same for more than one message, for instance the same for all messages with the same receiving user. Depending on the embodiment, the identification and/or authentication item(s) may or may not have been pre-existing prior to stage 302 of sending method 300. For instance, pre-existing identification and/or authentication item(s) may in some cases be item(s) which are the same for all messages with the same receiving user. In some of these embodiments, the identification and/or authentication item(s) may be determined through receipt (for instance in stage 502) from sending system 110. Additionally or alternatively in some of these embodiments, the identification and/or authentication item(s) may be generated, for instance by data generator 443. In some other embodiments, concealing and revealing system 140 (or any other module(s)/system(s) configured to conceal) may not need to receive nor determine identification and/or authentication item(s); for instance in some cases where sending system 110 is operable to retrieve, generate and/or modify identification and/or authentication item(s) on the fly, when receiving system 120 requests data, and/or in some cases where module(s)/system(s) configured to reveal reside in receiving system 120 and identification and/or authentication is not necessary.

In some embodiments, enabling subsequent obtainment may additionally or alternatively include concealing and revealing system 140, for instance concealing and revealing handler 444, (or any other module(s)/system(s) configured to conceal) storing data in an entry in memory 445 which corresponds to the message that will be sent out in stage 512. Additionally or alternatively, in embodiments with separate concealing system(s)/module(s) and revealing system(s)/modules, the data to be stored may be transferred to the separate revealing system(s)/module(s) and stored there and/or the data to be stored may be stored at the separate concealing system(s)/module(s).

The data stored may be any appropriate data, including for instance any of the following: at least some of the data which was received from sending system 110 but which the sent message conceals, identification and/or authentication item(s), an identifier or other identifying information which may be used in communication with sending system 110, data which enables matching between a request from receiving system 120 and the corresponding message, etc. For instance, the data which enables matching may include a code in the reference, data in the receiving user field(s), and/or any other identifying information (e.g. the body of the message, data in the “date/time” field and/or equivalent such as date/time sent and/or received, data in the “subject” field and/or equivalent, all data which was comprised in the message, etc). In some examples where a reference will be included in the message that will be sent, the reference may refer to an entry in memory 445 (or in any other memory) which corresponds to the message (optionally along with referring to other entry/ies corresponding to message(s) with the same reference).

In some cases, some or all of the data to be provided upon request to receiving system 120 may not be stored in memory 445 (nor in other memory at system(s)/module(s) configured to reveal and/or conceal). For instance, in some of these cases some or all of the data may be generated/modified on the fly when a request is received from receiving system 120, and/or may be retrieved, generated and/or modified by sending system 110 after the request is received. Assuming the data to be provided is not stored in external storage, then in some cases where a reference will be included in the message that will be sent, the reference may be a generic reference rather than referring specifically to one or more memory entries.

It is noted that in some embodiments, not necessarily all the data, which was received in stage 502 but which the sent message concealed, is stored and/or capable of being modified or generated on the fly. Some of this data, for instance, may not necessarily be interesting to the receiving user and therefore may be discarded completely (i.e. not stored or capable of being modified or generated). Continuing with this instance, in some cases the path taken by the message from sending system 110 to concealing and revealing system 140 (or to any other module(s)/system(s) configured to conceal), including for instance server(s) passed, even if concealed, may be not be stored nor capable of being modified and/or generated.

In some embodiments, prior to being sent in stage 512, the message may optionally be protected by concealing and revealing system 140, for instance by handler 444 (or by any other module(s)/system(s) configured to conceal). Protection by concealing and revealing system 140 may include any of the following: encryption, hashing using a one way function, digitally signing and/or encoding, etc. In other embodiments, the message may not be protected. In some cases this protection may be in addition to or instead of message protection performed at sending system 110.

In the illustrated embodiments in stage 512 the message is sent by concealing and revealing system 140, for instance by concealing communicator 442 (or by any other module(s)/system(s) configured to conceal) to one or more intended receiving user(s). In some cases where a message was received in stage 502, the message sent out may be the same as the message received if it was determined in stage 504 not to conceal data. In some cases where it was determined in stage 504 to conceal data, then the message sent out conceals at least some data. In some of these cases, the message at least conceals the identity of the sending user, but in others of these cases, the identity of the sending user may not necessarily be concealed.

In some embodiments with a plurality of intended receiving users, stage 512 may be repeated for each receiving user of a message, for instance because each copy of the message for a different receiving user has a different reference. In some other embodiments, stage 512 may not necessarily be repeated for each receiving user of a message, for instance if there is no reference, if the same reference corresponds to all receiving users and therefore the message with the same reference can be sent to all receiving users, or if there is a shared reference corresponding to a group of two or more receiving users and therefore the message with the shared reference can be sent to the corresponding receiving users. These latter embodiments may be appropriate for example when there are shared identification and/or authentication item(s), and/or identification and/or authentication items for more than one receiving user in this group is stored in memory as corresponding to a message. Additionally or alternatively, these latter embodiments may be appropriate if identity of the receiving user may be obtained otherwise, for example because a request for data includes information on the receiving user.

In some embodiments, concealing and revealing system 140 (or any other module(s)/system(s) configured to conceal) may set a timer after stage 512 in order to determine whether or not a predetermined time period will elapse without receiving a request for data corresponding to the sent message. In other embodiments no timer is set.

In the illustrated embodiments, in optional stage 514 it is determined by concealing and revealing system 140, for example by concealing and revealing communicator 442, (or by any other module(s)/system(s) configured to conceal) if a communication regarding the sent message should now be provided to sending system 110. If it is determined that a communication should be provided (yes to stage 514), then in the illustrated embodiments in optional stage 516 a communication is provided by concealing and revealing system 140, for instance by concealing communicator 442, (or by any other module(s)/system(s) configured to conceal) to sending system 110. For example, in some cases where the message was sent to an intended receiving user, a communication may be provided to sending system 110 indicating that the message was sent. As another example, additionally or alternatively, the communication may include the sent message. If no communication is to be provided at this point (no to stage 514), then in the illustrated embodiments stage 516 is skipped.

In some embodiments, stages 514 and 516 may be omitted, for instance if no communication regarding the sent message would ever be provided at this stage to sending system 110.

Assuming embodiments where a timer is set, in some of these embodiments if the predetermined time period elapses without receiving a request for data corresponding to the sent message, concealing and revealing system 140 (or any other module(s)/system(s) configured to conceal) may resend the message in the same manner as previously sent in stage 512 or may resend the message in a different manner. Sending in a different manner may include, in some instances, resending the message via a different communication channel. For example the different channel used for resending the message may be a direct connection which may be secure and/or authenticated from concealing and revealing system 140 (or from any other module(s)/system(s) configured to conceal) to receiving system 120. As another example the different channel may include a different message format. Continuing with the example, if the original message was sent as an email, the resent message may be sent as an SMS or instant message. Additionally or alternatively, in some instances where the message is resent in a different manner, the different manner may include resending the message using different contact information for the intended receiving user than used when originally sending the message, for example to an alternate mobile phone number, alternate email address, etc. In some of these instances, concealing and revealing system 140, for example concealing communicator 442, (or any other module(s)/system(s) configured to conceal) may receive the alternate contact information for intended receiving user(s) from the sending user, or the various contact options per intended receiving user including the alternate contact information may have been previously stored in memory (e.g. memory 445) and may therefore be accessible. In some instances, concealing and revealing system 140 (or any other module(s)/system(s) configured to conceal) may provide a communication to the sending user regarding the fact that the predetermined time period has elapsed and/or relating to the attempt to resend the message. Depending on the instance, where a message is resent in a different manner than previously sent, the message may or may not be modified prior to resending in order to better accommodate the different manner. Depending on the instance, where a message is resent, the message may or may not include a notification that the message is a resent message.

Assuming embodiments where a timer is set, in some of these embodiments, additionally or alternatively, if concealing and revealing system 140 (or any other module(s)/system(s) configured to reveal) receives a request for revealing data for a message which is old (i.e. a predetermined amount of time has already passed), the request may or may not be honored, depending on the embodiment. For instance, in some cases, a request may not be honored for an old message. In the illustrated embodiments, method 500 ends after stage 516.

FIG. 6 is a block diagram of receiving system 120, according to some embodiments of the presently disclosed subject matter. In the illustrated embodiments, receiving system 120 includes a receiving user input/output 622 configured to receive data from a receiving user associated with receiving system 120 and/or present data to a receiving user associated with receiving system 120, a receiving revealing manager 624 configured to request revealing data, and a receiving communicator 628 configured to communicate via channel 130 and/or via another channel in network 100. Optionally, receiving system 120 may also include a placement determiner 625 configured to determine and/or arrange placement of data, a receiving authenticator 626 configured to perform identification and/or authentication vis-a-vis concealing and revealing system 140 (or vis-a-vis any other module(s)/system(s) configured to reveal), a processor/executor 629 configured to process data for presentation, and/or a receiving memory 627 configured to store data. Receiving system 120 includes at least some hardware and in various embodiments, each of receiving user input/output 622, receiving revealing manager 624, receiving authenticator 626, receiving communicator 628, receiving memory 627, processor/executor 629 and/or placement determiner 625 may be made up of any combination of hardware, software and/or firmware capable of performing the operations as defined and explained herein. Examples of receiving user input/output 622 include keyboard, camera, mouse, keypad, touch-screen display, microphone, speaker, non-touch-screen display, and/or printer, etc. In some embodiments any of the modules in receiving system 120 may be included in any of the following: a web browser; a mail client; an instant messaging client; a peer-to-peer application, a user interface; an SMS application; an MMS application; a messaging application, any other type of Internet client; a plug-in, an add-on, a toolbar or an applet for a browser, email client, instant messaging client or any other application; a standalone client; any other suitable element servicing one user device; a gateway; a proxy server; any other type of server; a Web service; any other suitable element servicing multiple user devices; a third party website or application (e.g. mail aggregator); and/or an element with any other suitable configuration; etc.

In some cases, receiving system 120 may comprise fewer, more, and/or different modules than those shown in FIG. 6. Additionally or alternatively, in some cases, the functionality of receiving system 120 described herein may be divided differently among the modules of FIG. 6. Additionally or alternatively, in some cases, the functionality of receiving system 120 described herein may be divided into fewer, more and/or different modules than shown in FIG. 6 and/or receiving system 120 may include additional, less and/or different functionality than described herein. For example, receiving system 120 may include other module(s) for receiving messages in addition to or instead of one or more of the modules illustrated in FIG. 6. As another example, additionally or alternatively, receiving system 120 may include one or more modules of a receiving system in a network with message tracking, for instance as described in the aforementioned U.S. application Ser. No. 12/876,384. As another example, additionally or alternatively modules 624 and 626 may be combined together. As another example, additionally or alternatively, in some of these cases receiving system 120 may include one or more systems/modules for revealing, as will be described in more detail below.

Depending on the embodiment modules in receiving system 120 may be concentrated in one unit or separated among two or more units. Additionally or alternatively, depending on the embodiment, modules in receiving system 120 may be concentrated in the same location, for example in one unit or in various units in proximity of one another, or modules of receiving system 120 may be dispersed over various locations. For example, receiving system 120 may include an embedded display or a detached display when receiving user input/output 622 includes a display. As another example, additionally or alternatively, in some embodiments, modules in receiving system 120 may be divided into two sub-systems. Continuing with this example, in some of these embodiments the first subsystem may include receiving user input/output 622 and optionally a communicator to communicate with the second subsystem, the second subsystem may include receiving concealing and revealing manager 624, receiving authenticator 626 and receiving communicator 628. Optionally in this example, receiving memory 627, placement determiner 625 and/or processor/executor 629 may be included in both or one of the subsystem(s). In these embodiments, the two subsystems may or may not be located at the same location. As another example, additionally or alternatively, in some embodiments modules in receiving system 120 may be divided between a plurality of elements, with certain element(s) in the plurality selected from any of the following: a web browser, an email client, an instant messaging client, a peer-to-peer application, a user interface, a messaging application, an SMS application, an MMS application, any other type of Internet client, any other suitable element servicing one user device, a gateway, a proxy server, a Web service, any other type of server any other suitable element servicing multiple user devices, a third party website or application (e.g. mail aggregator), and/or an element with any other suitable configuration; and with other element(s) in the plurality selected from any of the following: an applet, toolbar, plug-in or add-on to a certain element, a standalone element associated with one user device, a gateway, a proxy server, any other type of server, a Web service, any other standalone element servicing multiple user devices, a third party website or application (e.g. mail aggregator); and/or a standalone element with any other suitable configuration. In these embodiments, the various elements may or may not be located at the same location.

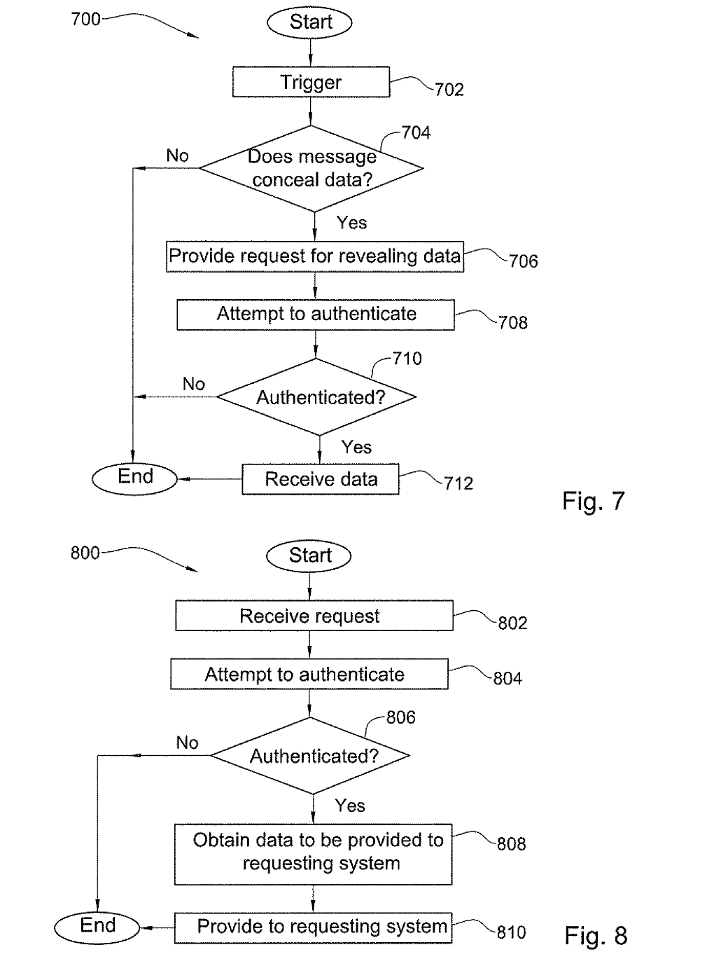

FIG. 7 is a flowchart of a method 700 of receiving revealing data, according to some embodiments of the presently disclosed subject matter. Method 700 is performed in some embodiments by receiving system 120. In some cases, method 700 may include fewer, more and/or different stages than illustrated in FIG. 7, the stages may be executed in a different order than shown in FIG. 7, stages that are illustrated as being executed sequentially may be executed in parallel, and/or stages that are illustrated as being executed in parallel may be executed sequentially.

In the illustrated embodiments in stage 702, a trigger occurs which causes receiving system 120 to perform stage 704.

For simplicity of description it is assumed in the illustrated embodiments that the trigger is an indication of message selection (e.g. opening) by a receiving user via receiving user input/output 622 (e.g. via keyboard, mouse, keypad, etc), for instance in order to view and/or listen to the message. In some examples of these embodiments, receiving system 120, for instance receiving communicator 628, may receive the message (including the message body) sent by concealing and revealing system 140 (or by any other module(s)/system(s) configured to conceal) and afterward the receiving user may select (e.g. open) the message. In some other examples of these embodiments, a message managing system, which for instance may correspond to a webmail operator, may receive the message (including the message body) from concealing and revealing system 140 (or from any other module(s)/system(s) configured to conceal) and may forward message data which is slated to be presented in a message list to receiving system 120 (e.g. to receiving communicator 628). In these examples, the receiving user may select (e.g. open) the message from the message list.

However in some embodiments, the trigger may not necessarily be selection (e.g. opening) by a receiving user of a particular message. For instance, the trigger may be any of the triggers described in co-pending U.S. application Ser. No. 12/911,192 filed on Oct. 25, 2010 which is hereby incorporated by reference herein, or any other suitable trigger. In some of these embodiments, receiving system 120 may select one or more messages from a message list, and/or may analyze the contents of a webpage which includes the message list, for instance as described in co-pending U.S. application Ser. No. 12/911,192. In these embodiments where receiving system 120 selects message(s) from a message list, receiving system 120 may perform method 704 and any subsequent relevant stages on each of the selected message(s).

In the illustrated embodiments in optional stage 704, receiving system 120, for instance receiving revealing manager 624, determines whether or not the selected message conceals data. For example, in some cases, the presence, format and/or content of a reference, the indicated concealing and revealing system 140 (or any other module(s)/system(s) configured to conceal) in the “From” field or equivalent, and/or a separate concealment indication in the message may allow receiving manager 624 to determine that the message conceals data. Similarly in this example, in some cases, the absence of a reference (or of a reference of certain format and/or content), a different sender indicated in the “From” field or equivalent and the absence of a separate indication may allow receiving manager 624 to determine that the message does not conceal data. In some examples of a message concealing data, the message may at least conceal the identity of the sending user (of that message or of a message associated with that message), but in other examples, the message may not necessarily conceal the identity of the sending user.

In some embodiments, a reference, and/or separate indication of concealment, which is/are located in a part of the message to be presented to the receiving user, may be removed from the message or otherwise hidden by receiving system 120, for instance by receiving manager 624, prior to presentation to the receiving user. In these embodiments the reference and/or other indication of concealment, even if included in the message, may therefore not be presented to the receiving user. In other embodiments an included reference and/or other indication of concealment may possibly be presented to the receiving user.

In some embodiments, stage 704 may optionally also include checking whether or not the received message is a duplicate of a message previously received. For example, in some of these embodiments, if concealing and revealing system 140 (or any other module(s)/system(s) configured to reveal) does not receive a request for revealing data within a predetermined time, the message may be sent by concealing and revealing system 140 (or by any other module(s)/system(s) configured to conceal) a second time. In some cases of these embodiments, both the original message and the second message may eventually be received (in any order) by receiving system 120. In embodiments where the received message is a duplicate of a message previously received, the message may in some cases be identified as a duplicate, for example based on a notification in the message that the message is a duplicate, based on an identifier and/or based on other identifying information in the message. Continuing with this example, other identifying information may include for instance data in the “From” field and/or equivalent such as sending user name and/or contact information, the user name and/or contact information of the receiving user corresponding to receiving system 120, the body of the message, data in the “date/time” field and/or equivalent such as date/time sent and/or received, data in the “subject” field and/or equivalent, all data which was comprised in the message, etc. Depending on the embodiment where a duplicate message has been identified, the remainder of method 700 may continue for the duplicate message resulting in a request for data provided for the duplicate message, or method 700 may end without sending a request relating to the duplicate message. Depending on the embodiment where a duplicate message has been identified, the duplicate message may or may not be deleted or otherwise hidden by receiving system 120. In embodiments where the duplicate message is deleted the deletion may occur at this stage or at a later point in time. For instance, the duplicate message can in some cases be deleted from the message store or user interface. Depending on the embodiment where a duplicate message has been identified, receiving system 120 may or may not inform concealing and revealing system 140 (or any other module(s)/system(s) configured to reveal) of the duplication. For example, in some cases, indication of the duplication may be included in a request if provided.

In the illustrated embodiments, if the message conceals data (yes to stage 704), then method 700 continues with stage 706. If instead, the message does not conceal data (no to stage 704) then in the illustrated embodiments method 700 ends and the received message is processed conventionally.

In embodiments, where all messages for the receiving user conceal data, for example because the receiving user has so requested, stage 704 may be omitted and the trigger in stage 702 may instead lead directly to the performance of stage 706.

In some embodiments, data which was previously requested may be saved, for instance in receiving memory 627. In these embodiments, prior to stage 706, receiving system 120, for instance receiving revealing manager 624 may check memory for any previously requested and received data, and if found, stages 706 to 710 may be omitted and in stage 712 the data may be retrieved from memory rather than received via a communication channel. In other embodiments, previously requested data may not be saved.

In the illustrated embodiments, in stage 706, receiving system 120, for instance receiving revealing manager 624, sends a request to concealing and revealing system 140 (or to any other module(s)/system(s) configured to reveal) to receive data, including for example revealing data. More specifically the request may be in some cases for revealing data which enables the determination of some or all of the data which a message, sent to the receiving user by revealing and concealing system 140 (or by any other module(s)/system(s) configured to conceal), concealed.

In some embodiments, the request may specify the data requested by receiving system 120.

In embodiments where the reference in the selected message included a pointer, the activation of the pointer by receiving manager 624, for instance, may function as a request to receive data as per the specification of the pointer.

In other embodiments a request may not be provided by activating a pointer. For instance, the reference in the selected message may not include a pointer but may include instead only a code, or the reference may include a pointer but receiving manager 624 may decide not to activate the pointer. In these other embodiments, receiving manager 624 may provide the request to receive data differently. First, receiving manager 624 may need to determine where to provide the request. The procedure for determining where to provide the request may differ depending on the embodiment.

In some of these other embodiments, an indicator of concealing and revealing system 140 (or of any other module(s)/system(s) configured to reveal) may be included in the code included in the reference (which may be comprised in any part of the sent message) and/or may be included in data in the “From” field or equivalent of the message. Receiving revealing manager 624 may look up in a look-up table contact information (such as a general URL) corresponding to the indicator which allows for contacting concealing and revealing system 140 (or any other module(s)/system(s) configured to reveal). The look up table, for example, may be stored in receiving memory 627 or in a location in network 100 accessible to receiving system 120, and the look-up table may associate indicators of module(s)/system(s) configured to reveal with corresponding contact information. Assuming an email message, in some examples the indicator may be the domain of the email address in the “From” field or equivalent, and receiving system 120 may look up the domain in the look-up table in order to obtain the corresponding contact information of concealing and revealing system 140 (or of any other module(s)/system(s) configured to reveal). In examples with a look-up table, the look-up table may in some instances be updatable via network 100, and/or may in some instances be managed by one or more module(s)/system(s) configured to conceal and/or to reveal, or by a third party. For example, receiving system 120 may periodically receive or pull updates of the association between indicators of module(s)/system(s) configured to reveal and corresponding direct contact information.

In some of these other embodiments, where there is only one central concealing and revealing system 140 (or only one other central system/module configured to reveal), receiving system 120 may know to provide the request to the central concealing and revealing system 140 (or to the other central system/module configured to reveal). Similarly, in some other of these embodiments, where the same plurality of central concealing and revealing systems 140 (or the same plurality of any other systems/modules configured to reveal) respond to requests for revealing data, receiving system 120 may know to provide the request to those central concealing and revealing systems 140 (or to those central other systems/modules configured to reveal).

In some of these other embodiments, where the system(s)/module(s) configured to reveal reside in receiving system 120, receiving system 120 may know to provide the request to that/those system(s)/module(s) residing in receiving system 120.

In some of these other embodiments, the determination of where to provide may be based on predetermined policy. For example, the predetermined policy may be to provide a request to all system(s)/module(s) configured to reveal (e.g. all concealing and revealing systems 140) in network 100 simultaneously. As another example, the predetermined policy may be to provide a request to all system(s)/module(s) configured to reveal (e.g. all concealing and revealing systems 140) in network 100 one by one until the correct system(s)/module(s) (e.g. correct concealing and revealing system(s) 140) is reached. As another example, the predetermined policy may be to provide a request to one system/module configured to reveal (e.g. one concealing and revealing system 140) in network 100, for instance a revealing system/module residing at receiving system 120, which then forwards the request to the correct system(s)/module(s) configured to reveal (e.g. correct concealing and revealing system(s) 140), or forwards the request to all other system(s)/module(s) configured to reveal (e.g. all other concealing and revealing systems 140) simultaneously or one by one until the correct system(s)/module(s) configured to reveal (e.g. correct concealing and revealing system(s) 140) is reached. In these examples, systems/modules configured to reveal (e.g. concealing and revealing systems 140) which receive irrelevant requests may report to receiving system 120 that the request is irrelevant, may discard the request and/or may perform any other appropriate response.

In some instances, a pointer which was included in a reference may be ignored in favor of other procedures for determining where to provide the request. For instance, instead of activating the pointer, receiving system 120 may decide to provide to the looked up system(s)/module(s) configured to reveal, to central system(s)/module(s) configured to reveal, to system(s)/module(s) configured to reveal residing in receiving system 120, to all system(s)/module(s) configured to reveal, or to one system/module configured to reveal for forwarding.

It is noted that depending on the embodiment, the ultimate destination for the request may include one or more systems/modules configured to reveal (e.g. one or more concealing and revealing systems 140). For instance, in some cases a plurality of systems/modules may be involved in responding to the request, for example for redundancy purposes, in order to achieve better response time, in order to split the stages of method 800 among more than one system/module, etc.

In embodiments where a pointer is not activated in order to provide the request, but rather other procedures are used to determine where to provide the request, receiving system 120, for instance receiving manager 624 may compose a request. The request may specify the requested revealing data by including data that will allow concealing and revealing system 140 (or any other module(s)/system(s) configured to reveal) to identify with sufficient probability at least the selected message. In some of these cases, the request may include a code from the reference which was included in the selected message. In some of these cases, the request may include other identifying information in addition to or instead of a reference code, such as the user name and/or contact information of the receiving user corresponding to receiving system 120, the body of the message, data in the “date/time” field and/or equivalent such as date/time sent and/or received, data in the “subject” field and/or equivalent, all data which was comprised in the message, etc. The disclosure does not limit the level of sufficient probability and in some cases the required level may be 100% but in other cases the level may be lower.

In some embodiments, where the data included in the request may identify with sufficient probability one or more messages including the selected message, the request may additionally or alternatively further specify to which message(s) data that is to be provided should be related. The further specification can cause the group of applicable messages to be broadened, narrowed, or remain the same compared to the message(s) previously identified. For example, the request may specify whether only data relating to the selected message should be provided, data relating to the last n (n≧1) message(s) for the corresponding receiving user should be provided, data relating to all message(s) for the corresponding receiving user should be provided, data relating to all message(s) for the corresponding user for which data has not been previously requested should be provided, data relating to all message(s) with the same reference should be provided, data relating to all message(s) with the same reference for which data has not been previously requested should be provided, etc.

Additionally or alternatively in some embodiments, the request may specify which revealing data should be provided for each related message, for instance all available retrievable modifiable and/or generatable data which enables determination of any data which the message concealed; retrievable, modifiable, and/or generatable data which enables determination of data from some or all header field(s) which the message concealed; retrievable, modifiable and/or generatable data which enables determination of some or all of data from the body of message which the message concealed, retrievable, modifiable and/or generatable data which enables determination of data corresponding to the reference which the message concealed, available retrievable modifiable and/or generatable data which enables determination of a subset of the data which message concealed, etc.

Additionally or alternatively, in some embodiments, the request may specify that for each related message, the entire message produced by sending system 110 is requested even if some of the data was previously sent by system 140 (or by any other module(s)/system(s) configured to conceal) in an iteration of stage 512, to the receiving user and is therefore not revealing data. Additionally or alternatively, the request may specify that for each related message all of the data which may be retrieved, modified and/or generated relating to the message (by sending system 110 by concealing and revealing system 140 and/or by another other module(s)/system(s) which is configured to conceal and/or reveal) is requested even if some of the data was included in the message previously sent to receiving system 120 in an iteration of stage 512 and is therefore not revealing data.

In some embodiments receiving system 120 may be able to perform stage 704 and/or 706 based on data in one or more of the header fields of the message whose data would be slated to be presented in a message list. For example, in some of these embodiments, assuming that a message list would include data from header field(s) such as one or more message receiving user field(s) (e.g. “to”, “cc” and/or equivalent), a “From” field and/or equivalent, a “Subject” field and/or equivalent, and/or a “Date/Time” field and/or equivalent, then a reference, indicator of concealing and revealing system 140 (or of any other module(s)/system(s) configured to reveal) not included in the reference, a separate indication of concealment, and/or other identifying information, if present, would be present in one or more of those fields. In other embodiments, a reference, indicator of concealing and revealing system 140 (or of any other module(s)/system(s) configured to reveal) not included in the reference, a separate indication of concealment, and/or other identifying information and/or a separate indication, if present, may be located anywhere in the message.

In some cases, there may be advantages to embodiments where receiving system 120 may perform stage 704 and/or 706 based on data in one or more message header fields whose data would be slated to be presented to a receiving user in a message list, rather than depending additionally or alternatively on data elsewhere in the message. For example, it may be faster for receiving system to perform stage 704 and/or 706 based on data in one or more of these header fields than based on data located elsewhere in the message. As another example, additionally or alternatively, assume that network 100 includes a message managing system and that data not presented to a receiving user in a message list would need to be requested from the message managing system separately from data that was presented in a message list. In this example, it may be faster and/or more efficient for receiving system 120 to perform stage 704 and/or 706, based on data in one or more of these header fields than based on data that would need to be separately requested from the message managing system. In this example, not having to retrieve additional data from the message managing system may additionally or alternatively provide the advantage that receiving system 120 does not need to be aware of how a particular message managing system handles data (since receiving system 120 may in some cases be configured to interact with a plurality of message managing systems). Additionally or alternatively, in another example it may be advantageous that receiving system 120 may be able to perform stage 704 and/or 706 based on data which would be slated to be presented in a message list, since this data may be always or almost always provided to receiving system 120 regardless of the receiving arrangement.

In the illustrated embodiments in optional stage 708, receiving system 120, for instance receiving authenticator 626, participates in an identification and/or authentication attempt vis-à-vis concealing and revealing system 140 (or any other module(s)/system(s) configured to reveal) in order to attempt to have system 140 identify and/or authenticate the receiving user and/or receiving system 120 as an intended receiving user and/or receiving system respectively. For example, identification and/or authentication may be achieved by receiving system 120, providing one or more correct identification and/or authentication item(s) such as a correct password, decryption key, access token, user credentials, etc. In some cases of this example, identification and/or authentication may be automatic, for instance by way of a remembered password or any other identification and/or authentication item, saved for instance in receiving memory 627. In another example, identification and/or authentication may be performed additionally or alternatively through input by the receiving user to receiving system 120 (e.g. via receiving user input/output 622), for instance a password or other identification and/or authentication item.

If the identification and/or authentication attempt is successful (yes to optional stage 710), then in the illustrated embodiments method 700 continues to state 712. In the illustrated embodiments, if the identification and/or authentication attempt is not successful, then method 700 ends. In other embodiments, identification and/or authentication may not be performed and stages 708 and 710 may be omitted. For example identification and/or authentication may in some cases not be required if concealing and revealing system 140 (or any other module(s)/system(s) configured to reveal) is in the same domain as receiving system 120, for instance if any other module(s)/system(s) configured to reveal reside in receiving system 120.

In the illustrated embodiments in stage 712, assuming identification and/or authentication has been achieved (or omitted), receiving system 120, for instance receiving revealing manager 624, receives at least some revealing data relating to the selected message. The data received in stage 712 may be received via the same network channel as the message was sent or via a different channel.

In some embodiments, the data received in stage 712 for any applicable message is the data requested. In other embodiments, the data received is not necessarily the data requested. For example, the request may not have specified which data was being requested. As another example, concealing and revealing system 140 (or any other module(s)/system(s) configured to reveal) and/or sending system 110 may have taken into account or ignored the specification in the request and provided data according to the interpretation of concealing and revealing system 140 (or any other module(s)/system(s) configured to reveal and/or conceal) and/or sending system 110.

Depending on the embodiment, it may be possible for receiving system 120 to receive relating to any applicable message revealing data which enables determination of all data which the message concealed and which may be retrieved, modified and/or generated, or it may be possible for receiving system 120 to receive revealing data which enables determination of only some of the data which the message concealed and which may be retrieved, modified and/or generated. For instance, in some cases the identifier, the path taken by the message provided from sending system 110 to concealing and revealing system 140 (or to any other module(s)/system(s) configured to conceal), and/or identification and/or authentication item(s), etc., may have been concealed, may be retrieved, modified and/or generated but although useful for sending system 110 and/or concealing and revealing system 140 (or for any other module(s)/system(s) configured to conceal), it may not be desirable to provide one or more of these to receiving system 120. Depending on the embodiment, revealing data which enables determination of all of the concealed data relating to a particular message may be retrieved, modified and/or generated or revealing data which enables determination of only some of the concealed data relating to a particular message may be retrieved, modified and/or generated. For instance, in some cases some of the concealed data may have been discarded completely. Continuing with this instance, in some of these cases the path taken by the message provided from sending system 110 to concealing and revealing system 140 may have been discarded completely.

In some embodiments, where it may be possible for receiving system 120 to receive revealing data which enables determination of only some of the data which the message concealed and which may be retrieved, modified and/or generated, the amount of data which is in fact received may be based on a result of the identification and/or authentication attempt. For instance, more or less data may be received depending on the provided identification and/or authentication item(s).

In some embodiments, the data received in stage 712 at least reveals the identity of the sending user of the selected message or of a message associated with the selected message. However in other embodiments, the revealing data may not necessarily reveal the identity.

In some embodiments, once the revealing data has been received, receiving system 120 may have access to a message which is in compliance with the standard of the message originally generated by sending system 110 (for instance in any of stages 302 to 310).

In some embodiments, after receiving the data in stage 712 receiving system 120, for instance placement determiner 625, determines the placement and/or arranges the placement of previously concealed data which said received revealing data enabled to determine, or version thereof.

In some embodiments, the placement of previously concealed data or version thereof relating to a particular message may be arranged to be in a separate window or application than the particular message previously sent by concealing and revealing system 140 (or by any other module(s)/system(s) configured to conceal) or version thereof. In some other embodiments, the placement of previously concealed data or version thereof relating to a particular message may be arranged to be in the same window as the particular message previously sent by concealing and revealing system 140 (or by any other module(s)/system(s) configured to conceal) or version thereof. For instance, the placement of the received data or version thereof may be arranged so that previously concealed data or version thereof relating to a particular message may appear in the window in addition to the particular message or version thereof, or replacing part or all of the particular message or version thereof.

In some other embodiments, placement and/or arrangement of previously concealed data or version thereof with respect to the particular message or version thereof may not be necessary. For instance in cases where revealing data is received via a different channel, arrangement and placement with respect to the particular message may or may not be applicable.

In some embodiments, the processing for output to the receiving user of the particular message previously sent by concealing and revealing system 140, or version thereof, and/or of the related previously concealed data or version thereof may be performed by receiving system 120, for instance by processor/executor 629, (for instance before and/or after the determination and/or arrangement of the placement of the previously concealed data, if performed). In some embodiments, the message previously sent by concealing and revealing system 140 (or by any other module(s)/system(s) configured to conceal) or version thereof and the previously concealed data or version thereof may be outputted to the receiving user via receiving user input/output 622. In some other embodiments, only the previously concealed data or version thereof may be outputted to the receiving user via receiving user input/output 622. For instance, if the revealing data was received via a different channel, then depending on the embodiment, the message may or may not be outputted at this stage.

The disclosure does not impose limitations on the determination of placement, arrangement of placement, processing for output and/or output to the receiving user, if performed. In some embodiments, receiving system 120 may determine the arrangement, arrange the placement, process for output, and/or output to the receiving user as described in co-pending U.S. application Ser. No. 13/193,120, titled “Enabling active content in messaging using automatic data replacement”, and filed on Jul. 28, 2011, which is hereby incorporated by reference herein.

Depending on the embodiment, some or all of the data received in stage 712 may or may not be stored. For instance, in some embodiments where data relating to messages is stored in memory accessible to the Internet service provider and/or webmail provider or to another other third party, the receiving user may prefer that at least some of the received data not be stored. In these embodiments, method 706 to 710 would need to be repeated next time there is a trigger. Additionally or alternatively, in some embodiments, at least some of the data received in stage 712 may be stored, for instance because the data may be stored in a memory not accessible to a third party or for any other reason. In these embodiments, the revealing data relating to a message would need only be received once from concealing and revealing system 140. Depending on the embodiment, data may be stored for an unlimited amount of time or for a limited amount of time.

In the illustrated embodiments, after stage 712 method 700 ends.

In some embodiments, receiving system 120 may additionally or alternatively communicate with concealing and revealing system 140 (or with any other module(s)/system(s) configured to reveal) not necessarily requesting data. For instance, receiving system 120 may provide a reply including a “Reply-To” indicator. The reply to indicator in this instance may allow concealing and revealing system 140 (or any other module(s)/system(s) configured to reveal) to forward the reply to (the correct) sending user. Depending on the embodiment, concealing and revealing system 140 (or any other module(s)/system(s) configured to reveal) may or may not require identification and/or authentication of the receiving user and/or system 120 prior to forwarding the reply to the sending user. Alternatively, receiving system 120 may provide a reply which does not include a “Reply to” indicator (since the indicator may not have been in the message sent by system 140 (or by any other module(s)/system(s) configured to conceal) and only afterwards (for example after identification and/or authentication), receiving system 120 may receive a Reply-to indicator which may allow the receiving user to provide a reply to the sending user, either directly or via concealing and revealing system 140 (or via any other module(s)/system(s) configured to reveal).

FIG. 8 is a flowchart of a method 800 of providing revealing data, according to some embodiments of the presently disclosed subject matter. Method 800 may be performed in various embodiments by any system(s)/module(s) configured to reveal. Examples of such system(s)/module(s) may include a single concealing and revealing system 140, a plurality of concealing and revealing systems 140, one or more concealing and revealing module(s), or (separate) revealing system(s)/module(s) which is/are not also configured to conceal. (In embodiments with separate revealing system(s)/module(s), the separate concealing system(s)/module(s) may or may not reside in receiving system 120). For simplicity of description and illustration, the illustrated embodiments of method 800 refer to a single concealing and revealing system 140.

In some cases, method 800 may include fewer, more and/or different stages than illustrated in FIG. 8, the stages may be executed in a different order than shown in FIG. 8, stages that are illustrated as being executed sequentially may be executed in parallel, and/or stages that are illustrated as being executed in parallel may be executed sequentially.

In the illustrated embodiments in stage 802, concealing and revealing system 140, for instance concealing and revealing communicator 442 (or any other module(s)/system(s) configured to reveal) receives a request from a requesting system, for instance from receiving system 120. Depending on the embodiment, the request may have been transferred externally via channel 130 or another channel in network 100, or internally in the case that module(s)/system(s) configured to reveal reside in receiving system 120.

In some embodiments, where a pointer was activated in order to provide the request, corresponding message(s) may be determined as per the pointer specification.

In some embodiments where a pointer was not activated in order to provide the request but rather other procedures were used to determine where to provide the request, the request may include data which will allow concealing and revealing system 140 (or any other module(s)/system(s) configured to reveal) to identify with sufficient probability corresponding message(s) sent by concealing and revealing system 140 (or any other module(s)/system(s) configured to conceal) to the requesting user. In some of these embodiments, the request may include a code from a reference which was included in a message. In some of these embodiments, the request may include other identifying information in addition to or instead of a reference code, such as the user name and/or contact information of the receiving user corresponding to receiving system 120, the body of the message, data in the “Date/Time” field and/or equivalent such as date/time sent and/or received, data in the “Subject” field and/or equivalent, all data which was comprised in the message, etc. The disclosure does not limit the level of sufficient probability and in some cases the required level may be 100% but in other cases the level may be lower.

In some embodiments, where one or more messages may be identified with sufficient probability from the data included in the request or pointer specification, the request may additionally or alternatively further specify and/or system 140 (or any other module(s)/system(s) configured to reveal) and/or 110 may further interpret to which message(s) data that is to be provided should be related. The further specification or interpretation can cause the group of applicable messages to be broadened, narrowed, or remain the same compared to the message(s) previously identified. For example, the further specification and/or may interpretation may mean that the applicable message(s) are any of the following: a single message, the last n (n≧1) message(s) for the corresponding receiving user, all message(s) for the corresponding user for which data has not been previously provided to the user, all message(s) with the same reference should be provided, all message(s) with the same reference for which data has not been previously provided, etc.

In some embodiments, the request may be recognized as a duplicate of a request previously received, for instance because the request includes an indication that the request is a duplicate or for instance after identifying. Depending on the embodiment, the remainder of method 800 may or may not be performed for a duplicate request.

In some embodiments, the request may be recognized as relating to an old message (where a predetermined amount of time has expired). Depending on the embodiment, the remainder of method 800 may or may not be performed if relating to an old message.

In the illustrated embodiments, in optional stage 804, concealing and revealing system 140, for instance concealing and revealing authenticator 446, (or any other module(s)/system(s) configured to reveal) attempts to authenticate and/or identify the requesting system and/or the associated requesting user. For example, authentication and/or identification may be achieved by checking that the requesting system provided one or more correct identification and/or authentication item(s) such as the correct password, decryption key, access token user credentials, etc. In other embodiments, identification and/or authentication may not be performed and therefore stages 804 and 806 may be omitted. For example identification and/or authentication may in some cases not be required if system 140 (or any other module(s)/system(s) configured to reveal) is in the same domain as receiving system 120, e.g. residing in receiving system 120.

For instance, concealing and revealing system 140, e.g. concealing and revealing authenticator 446 (or any other module(s)/system(s) configured to reveal) may authenticate and/or identify a requesting user and/or requesting system by checking identification and/or authentication item(s) provided by the requesting system against identification and/or authentication item(s) for applicable message(s), where the identification and/or authentication item(s) may be retrieved from memory (e.g. concealing and revealing memory 445) and/or modified and/or generated on the fly by an authenticator (e.g. concealing and revealing authenticator 446). Alternatively or additionally, an authenticator (e.g. concealing and revealing authenticator 446) may authenticate and/or identify a requesting user and/or requesting system by sending a communication to sending system 110 asking sending system 110 to check identification and/or authentication item(s) provided by the requesting system against identification and/or authentication item(s) for applicable message(s), where the identification and/or authentication item(s) may be retrieved from sending memory 215 and/or may be modified and/or generated on the fly by protector 218.

In embodiments where module(s)/system(s) configured to reveal is/are separate from module(s)/system(s) configured to conceal, identification and/or authentication attempt 804 may or may not also involve the module(s)/system(s) configured to conceal. For instance, in some of these embodiments, module(s)/system(s) configured to reveal may authenticate and/or identify a requesting user and/or requesting system by sending a communication to the module(s)/system(s) configured to conceal asking the module(s)/system(s) configured to conceal to check identification and/or authentication item(s) provided by the requesting system against identification and/or authentication item(s) for applicable message(s), where the identification and/or authentication item(s) may be retrieved from memory and/or may be modified and/or generated on the fly by the module(s)/system(s) configured to conceal. However, in other of these embodiments, module(s)/system(s) configured to reveal may not communicate at this stage with module(s)/system(s) configured to reveal regarding identification and/or authentication (but possibly may have done so previously).

In the illustrated embodiments, in optional stage 806, concealing and revealing system 140, for instance concealing and revealing authenticator 446 (or any other module(s)/system(s) configured to reveal) determines if identification and/or authentication has been achieved. If not achieved (no to stage 806), then in the illustrated embodiments method 800 ends, optionally with concealing and revealing system 140 (or any other module(s)/system(s) configured to reveal) informing the requesting system that authentication and/or identification failed. For instance, assuming that the requesting system is not a receiving system associated with the intended receiving user of the message(s) corresponding to the request and/or the requesting user which is requesting identification/authentication is not an intended receiving user of the message(s) corresponding to the request. In such instances, authentication and/or identification may fail.

If instead identification and/or authentication has been achieved (yes to stage 806) or omitted, then in the illustrated embodiments, in stage 808, concealing and revealing system 140, for instance concealing and revealing handler 444 (or any other module(s)/system(s) configured to reveal) obtains data relating to the applicable message(s), in response to the request. In the illustrated embodiments, the data obtained will be provided to the requesting system in stage 810.

In some embodiments, the data obtained is the data requested. In other embodiments, the data obtained is not necessarily the data requested. For example, the request may not have specified which data was being requested. As another example, concealing and revealing system 140 (or any other module(s)/system(s) configured to reveal) and/or sending system 110 may take into account or ignore the specification in the request and therefore data may be obtained according to the interpretation of concealing and revealing system 140 (or any other module(s)/system(s) configured to reveal) and/or sending system 110.

Additionally or alternatively, in some embodiments, the obtained data relating to a particular message, which will be provided to the requesting system, may include at least some revealing data which enables determination of some or all of the data that the particular message concealed.

For example, the request may have specified and/or system 140 and/or 110 may interpret which revealing data should be obtained for each applicable message, for instance all available retrievable modifiable and/or generatable data which enables determination of any data which the message concealed; retrievable, modifiable, and/or generatable data which enables determination of data from some or all header field(s) which the message concealed; retrievable, modifiable and/or generatable data which enables determination of some or all of data from the body of message which the message concealed, retrievable, modifiable and/or generatable data which enables determination of data corresponding to the reference which the message concealed, available retrievable modifiable and/or generatable data which enables determination of a subset of the data which message concealed, etc.

Continuing with this example, in some cases, the data obtained relating to a particular message may at least include data which reveals the identity of the sending user of the particular message or of a message associated with the particular message, such as data that would typically although not necessarily be included in the “From” field or equivalent if not concealed. However, in other cases, the data obtained may not necessarily reveal the identity of the sending user.

Continuing with this example, additionally or alternatively in various cases it may or may not be desirable to obtain data which would enable determination of all data which a particular message concealed and which may be retrieved, modified and/or generated. For instance, in some cases it may not be desirable to obtain data which would enable the determination of certain concealed data. In some of these cases, the identifier, the path taken by the message provided from sending system 110 to concealing and revealing system 140 (or to any other module(s)/system(s) configured to conceal) and/or identification and/or authentication item(s), etc. may have been concealed, may be retrieved, modified and/or generated but although useful for sending system 110 and/or concealing and revealing system 140 (or any other module(s)/system(s) configured to conceal), it may not be desirable to provide one or more of these to the requesting system.

Still continuing with this example, additionally or alternatively in various cases it may or may not be possible to obtain data which reveals all data which a particular message concealed. In some of these cases, revealing data relating to only some of the data concealed by a particular message may be retrieved, modified and/or generated. For instance, some of the data concealed by the message may have been discarded completely. Continuing with this instance, the path taken by the message or by an associated message provided from sending system 110 to concealing and revealing system 140 (or any other module(s)/system(s) configured to conceal) may perhaps have been discarded completely.

Depending on the embodiment, the request may have specified and/or system 140 (or any other module(s)/system(s) configured to reveal) and/or system 110 may interpret whether the obtained data may include only revealing data or may also include other data. As an example of the latter embodiments, in some cases, the obtained data may include the original message(s) produced by sending system 110 even if some of the data was included in message(s) sent to receiving system 120 in corresponding stage(s) 512. As another example of the latter embodiments, in some cases, the obtained data may include all of the data which is stored, may be modified and/or may be generated relating to the message(s) by sending system 110 and/or concealing and revealing system 140 (or by any other module(s)/system(s) configured to reveal) even if some of the data was included in message(s) previously sent in corresponding stage(s) 512.

The obtained data may be obtained from concealing and revealing system 140 (or from any other module(s)/system(s) configured to reveal) and/or from sending system 110, depending on the embodiment. The obtained data may be generated, retrieved, and/or may be a modification of retrieved data (e.g. updated data), depending on the embodiment. For instance, data may be retrieved from memory (e.g. concealing and revealing memory 445) and/or data may be generated and/or modified by a data generator (e.g. data generator 443). Additionally or alternatively in another instance, concealing and revealing system 140, for instance concealing and revealing handler 444 (or any other module(s)/system(s) configured to reveal) may provide a communication to sending system 110 asking for data. Data may then be generated and/or modified by sending system 110, for example by message producer 214. Additionally or alternatively, for example data may then be retrieved from sending memory 215. Sending system 110 may provide the generated, modified, and/or retrieved data to concealing and revealing system 140 (or to any other module(s)/system(s) configured to reveal).

In embodiments where module(s)/system(s) configured to reveal is/are separate from module(s)/system(s) configured to conceal, data obtainment 808 may or may not involve the module(s)/system(s) configured to conceal. For instance, in some of these embodiments, module(s)/system(s) configured to reveal may obtain data by sending a communication to the module(s)/system(s) configured to conceal for data, where the data may be retrieved from memory and/or may be modified and/or generated on the fly by the module(s)/system(s) configured to conceal. However in other of these embodiments, data may be obtained without communication at this stage with module(s)/system(s) configured to conceal (although communication may have possibly occurred previously).

In the illustrated embodiments, in stage 810, concealing and revealing system 140, for instance concealing and revealing handler 444 (or any other module(s)/system(s) configured to reveal) provides the obtained data to the requesting system, for example to receiving system 120. Depending on the embodiment, the data may be transferred externally via channel 130 or another channel in network 100, or internally in the case that module(s)/system(s) configured to reveal reside in receiving system 120.

In the illustrated embodiments, method 800 then ends.

In some cases, method 800 may be repeated for the same message (sent in stage 512) to a plurality of receiving users, as different receiving systems associated with the different receiving users provide requests. It is noted that in embodiments with a plurality of receiving users, requests from different receiving users for the same message may or may not be distinguishable.

In some embodiments, concealing and revealing system 140 (or any other module(s)/system(s) configured to reveal) may additionally or alternatively receive requests which are not for data. For instance, concealing and revealing system 140 (or any other module(s)/system(s) configured to reveal) may receive a reply including a “Reply to” indicator from requesting system, e.g. receiving system 120. The reply to indicator in this instance may allow concealing and revealing system 140 (or any other module(s)/system(s) configured to reveal) to forward the reply to (the correct) sending user. In some cases of this instance, concealing and revealing system 140 (or any other module(s)/system(s) configured to reveal) may add information to the reply (e.g. identifying information such as the identifier) prior to forwarding the reply so that the reply may be matched to the message. Depending on the embodiment, concealing and revealing system 140 (or any other module(s)/system(s) configured to reveal) may or may not require identification and/or authentication of the requesting user and/or system prior to forwarding the reply to the sending user. Alternatively, for instance, concealing and revealing system 140 (or any other module(s)/system(s) configured to reveal) may receive a reply which does not include a “Reply-to” indicator (since the indicator had not been in the message sent by system 140 or by any other module(s)/system(s) configured to conceal) and only afterwards (e.g. after identifying and/or authenticating the requesting user and/or system), system 140 (or any other module(s)/system(s) configured to reveal) may provide a Reply-to indicator which will allow the requesting user to provide a reply to the sending user, either directly or via concealing and revealing system 140 (or via any other module(s)/system(s) configured to reveal).

In embodiments where module(s)/system(s) configured to reveal is/are separate from module(s)/system(s) configured to conceal, Reply-to forwarding may or may not involve the module(s)/system(s) configured to conceal.

In some embodiments, it may be advantageous that the message sent by concealing and revealing system 120 in method 500 conceals data, and that revealing data which enables determination of concealed data is only provided upon request (e.g. after identification and/or authentication of the receiving user). For instance, an Internet service provider Webmail provider, and/or other third parties may have access to messages sent by concealing and revealing system 120 (or any other module(s)/system(s) configured to conceal) and therefore a receiving user may prefer that this access not include access to certain data.

It will also be understood that in some embodiments a system or part of a system according to the presently disclosed subject matter may be a suitably programmed machine. Likewise, some embodiments of the presently disclosed subject matter contemplate a computer program being readable by a machine for executing a method of the presently disclosed subject matter. Some embodiments of the presently disclosed subject matter further contemplate a machine-useable medium tangibly embodying program code readable by the machine for executing a method of the presently disclosed subject matter.

While the presently disclosed subject matter has been shown and described with respect to particular embodiments, it is not thus limited. Numerous modifications, changes and improvements within the scope of the presently disclosed subject matter will now occur to the reader.

1. A method of providing revealing data which enables determination of at least some data which a message concealed, comprising:
receiving a request relating to a sent message which concealed data; and
in response to said request, providing revealing data which enables determination of at least some data which said message concealed.

2. The method of claim 1, further comprising:
authenticating a user as being an intended receiving user of said message prior to providing said revealing data.

3. The method of claim 1, further comprising:
receiving an indication of a message from a sending user which is intended for at least one receiving user, and sending a message to at least one of said at least one intended receiving user which conceals data.

4. The method of claim 3, further comprising:
providing said indication of a message from said sending user which is intended for said at least one receiving user.

5. The method of claim 1, further comprising:
in response to said request, obtaining said revealing data which is later provided by performing at least one action selected from a group comprising: retrieving data, generating data, or modifying data.

6. The method of claim 1, wherein said message at least concealed an identity of a sending user of said message or of an associated message.

7. The method of claim 1, further comprising:
determining that said message conceals data;
providing said request; and
in response to said request, receiving revealing data which enables determination of at least some data which said message concealed; and
outputting to a user at least some data which said message concealed and which said revealing data enabled to determine.

8. The method of claim 7, further comprising:
prior to receiving said revealing data, providing at least one item which allows said user to be authenticated as an intended receiving user of said message.

9. A method of concealing message data, comprising:
receiving an indication of a message which is intended for at least one receiving user, and
sending a message to at least one of said at least one intended receiving user which conceals at least some data that would not be concealed if the indicated message were sent to said at least one of said at least one intended receiving user;
wherein revealing data which enables determination of at least some data which said message concealed, is only provided to an intended receiving user upon request.

10. The method of claim 9, further comprising:
providing a request relating to said sent message;
in response to said request, receiving revealing data which enables determination of at least some data which said message concealed; and
outputting to a user at least some data which said message concealed and which said revealing data enabled to determine.

11. The method of claim 10, further comprising:
prior to receiving said revealing data, providing at least one item which allows said user to be authenticated as an intended receiving user of said message.

12. The method of claim 9, further comprising:
receiving a request relating to said sent message; and
in response to said request, providing revealing data which enables determination of at least some data which said sent message concealed.

13. The method of claim 9, wherein said sent message at least concealed an identity of a sending user of said message for which an indication was received.

14. The method of claim 9, further comprising:
manipulating said message whose indication was received, or a part thereof, into a message to be sent to said at least one of said intended receiving users.

15. The method of claim 9, further comprising:
creating a message to be sent to said at least one of said at least intended receiving user.

16. A method of concealing and revealing message data, comprising:
providing an indication of a message from said sending user which is intended for at least one receiving user;
sending a message to at least one of said at least one intended receiving user which conceals data;
providing a request relating to said sent message;
in response to a request relating to said sent message, providing revealing data which enables determination of at least some data which said message concealed; and
outputting to a user at least some data which said message concealed and which said revealing data enabled to determine.

17. A receiving system, comprising:
a user output operable to output at least some data which a sent message concealed and which revealing data, provided upon request, enabled to determine.

18. The receiving system of claim 17, further comprising:
a manager operable to determine that a sent message concealed data, to provide a request relating to said message, and to receive revealing data which enables determination of at least some data which said message concealed.

19. The receiving system of claim 17, further comprising:
a handler operable, in response to said request, to obtain and provide revealing data which enables determination of at least some data which said message concealed.

20. The receiving system of claim 17, further comprising:
an authenticator, operable to provide at least one authentication item in an attempt to have a user authenticated as an intended receiving user of said message.

21. A system for concealing and revealing data, comprising:
a communicator operable to receive indication of a message from a sending user which is intended for at least one receiving user, to send a message to at least one of said at least one receiving user which conceals data, and to receive a request for revealing data which enables determination of at least some data which said message concealed; and
an authenticator operable to authenticate or not authenticate a user associated with said request as being an intended receiving user of said message;
wherein said communicator is further operable to send revealing data which enables determination of at least some data which said message concealed, if said user has been authenticated as being an intended receiving user of said message.

22. A sending system, comprising:
a message producer operable to produce a message intended for at least one receiving user;
wherein instead of said produced message being sent to an intended receiving user, a message derived from manipulating said message or a part thereof, or a created message is sent to said intended receiving user and conceals data which would not have been concealed had said produced message been sent; and wherein revealing data which enables determination of at least some data which said sent out message concealed is provided only upon request.

23. The system of claim 22, further comprising:
a handler operable to create a message to be sent out which conceals data or to manipulate said produced message or a part thereof into a message to be sent out which conceals data; and
a communicator operable to send said message which conceals data to at least one of said at least one intended receiving user.

24. A computer program product comprising a computer useable medium having computer readable program code embodied therein for providing revealing data which enables determination of at least some data which a message concealed, the computer program product comprising:
computer readable program code for causing the computer to receive a request relating to a sent message which concealed data; and
computer readable program code for causing the computer, in response to said request, to provide revealing data which enables determination of at least some data which said message concealed.

25. A computer program product comprising a computer useable medium having computer readable program code embodied therein for concealing message data, the computer program product comprising:
computer readable program code for causing the computer to receive an indication of a message which is intended for at least one receiving user; and
computer readable program code for causing the computer to send a message to at least one of said at least one intended receiving user which conceals at least some data that would not be concealed if the indicated message were sent to said at least one of said at least one intended receiving user;
wherein revealing data which enables determination of at least some data which said message concealed, is only provided to an intended receiving user upon request.
